SEQUENCE LISTING (14 sequences)

SEQ ID NO: 1 - protein, 225 aa, Aspergillus oryzae
VPVNPEPDATSVENVALKTGSGDSQSDPIKADLEVKGQSALPFDVMCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALMFSLGSNDKSVCDKNKNIAGDWGFDPAKWAYQYDEKNNKFNYVGK

SEQ ID NO: 2 - protein, 109 aa, Bacillus licheniformis
ARYDDILYFPASRYPETGAHISDAIKAGHSDVCTIERSGADKRRQESLKGIPTKPGFDRDEWPMAMCEEGGKGASVRYVSSSDNRGAGSWVGNRLSGFADGTRILFIVQ

SEQ ID NO: 3 - protein, 110 aa, Bacillus subtilis
ASSYDKVLYFPLSRYPETGSHIRDAIAEGHPDICTIDRDGADKRREESLKGIPTKPGYDRDEWPMAVCEEGGAGADVRYVTPSDNRGAGSWVGNQMSSYPDGTRVLFIVQ

SEQ ID NO: 4 - protein, 245 aa, Serratia marcescens
DTLESIDNCAVGCPTGGSSNVSIVRHAYTLNNNSTTKFANWVAYHITKDTPASGKTRNWKTDPALNPADTLAPADYTGANAALKVDRGHQAPLASLAGVSDWESLNYLSNITPQKSDLNQGAWARLEDQERKLIDRADISSVYTVTGPLYERDMGKLPGTQKAHTIPSAYWKVIFINNSPAVNHYAAFLFDQNTPKGADFCQFRVTVDEIEKRTGLIIWAGLPDDVQASLKSKPGVLPELMGCKN

SEQ ID NO: 5 - protein, 182 aa, Bacillis Idriensis
LPPGTPSKSTAQSQLNALTVQTEGSMTGYSRDKFPHWISQGNGCDTRQVVLQRDADYYSGTCPVTSGKWYSYYDGVTLYNPSDLDIDHVVALAEAWRSGASSWTTDKREDFANDLSGTQLIAVSASTNRSKGDQDPSTWQPPRSGAACGYAKWWISTKYKWNLNLQSSEKTALQSMLNSCSY

SEQ ID NO: 6 - protein, 182 aa, Bacillus cibi [sequence omitted]

SEQ ID NO: 7 - protein, 182 aa, Bacillus horikoshii
LPPGTPSKSEAQSQLNSLTVKSEDPMTGYSRDHFPHWSGQGNGCDTRQIVLQRDADYYSGNCPVTSGKWYSYFDGVIVYSPSEIDIDHVVPLAEAWRSGASSWTTEQRRSFANDLNGPQLIAVTASVNRSKGDQDPSTWQPPRAGARCAYAKWWINTKHRWNLHLQSSEKSALQTMLNGCVY

SEQ ID NO: 8 - protein, 182 aa, Bacillus sp.
FPPEIPSKSTAQSQLNSLTVKSEDAMTGYSRDKFPHWISQGDGCDTRQMVLKRDADYYSGSCPVTSGKWYSYYDGITVYSPSEIDIDHIVPLAEAWRSGASSWTTEKRRNFANDLNGPQLIAVTASVNRSKGDQDPSTWQPPRSGARCAYAKMWVNTKYRWGLHLQSAEKSGLESMLNTCSY

SEQ ID NO: 9 - protein, 182 aa, Bacillus sp.
LPPGTPSKSEAQSQLTSLTVKPEDPMTGYSRDHFPHWISQGNGCNTRQIVLQRDADYYSGNCPVTTGKWYSYFDGVIVYSPSEIDIDHIVPLAEAWRSGASSWTAEQRRNFANDLNGPQLIAVTASVNRSKGDQDPSTWQPPRTGARCAYAKWWINTKYRWGLHLQSSEKSSLQSMLNGCAY

SEQ ID NO: 10 - protein, 415 aa, Humicola insolens
QKPGETKEVHPQLTTFRCTKRGGCKPATNFIVLDSLSHPIHRAEGLGPGGCGDWGNPPPKDVCPDVESCAKNCIMEGIPDYSQYGVTTNGTSLRLQHILPDGRVPSPRVYLLDKTKRRYEMLHLTGFEFTFDVDATKLPCGMNSALYLSEMHPTGAKSKYNPGGAYYGTGYCDAQCFVTPFINGLGNIEGKGSCCNEMDIWEANSRASHVAPHTCNKKGLYLCEGEECAFEGVCDKNGCGWNNYRVNVTDYYGRGEEFKVNTLKPFTVVTQFLANRRGKLEKIHRFYVQDGKVIESFYTNKEGVPYTNMIDDEFCEATGSRKYMELGATQGMGEALTRGMVLAMSIWWDQGGNMEWLDHGEAGPCAKGEGAPSNIVQVEPFPEVTYTNLRWGEIGSTYQEVQKPKPKPGHGPRSD

SEQ ID NO: 11 - protein, 773 aa, Bacillus akibai
AEGNTREDNFKHLLGNDNVKRPSEAGALQLQEVDGQMTLVDQHGEKIQLRGMSTHGLQWFPEILNDNAYKALANDWESNMIRLAMYVGENGYASNPELIKSRVIKGIDLAIENDMYVIVDWHVHAPGDPRDPVYAGAEDFFRDIAALYPNNPHIIYELANEPSSNNNGGAGIPNNEEGWNAVKEYADPIVEMLRDSGNADDNIIIVGSPNWSQRPDLAADNPINDHHTMYTVHFYTGSHAASTESYPPETPNSERGNVMSNTRYALENGVAVFATEWGTSQANGDGGPYFDEADVWIEFLNENNISWANWSLTNKNEVSGAFTPFELGKSNATNLDPGPDHVWAPEELSLSGEYVRARIKGVNYEPIDRTKYTKVLWDFNDGTKQGFGVNSDSPNKELIAVDNENNTLKVSGLDVSNDVSDGNFWANARLSADGWGKSVDILGAEKLTMDVIVDEPTTVAIAAIPQSSKSGWANPERAVRVNAEDFVQQTDGKYKAGLTITGEDAPNLKNIAFHEEDNNMNNIILFVGTDAADVIYLDNIKVIGTEVEIPVVHDPKGEAVLPSVFEDGTRQGWDWAGESGVKTALTIEEANGSNALSWEFGYPEVKPSDNWATAPRLDFWKSDLVRGENDYVAFDFYLDPVRATEGAMNINLVFQPPTNGYWVQAPKTYTINFDELEEANQVNGLYHYEVKINVRDITNIQDDTLLRNMMIIFADVESDFAGRVFVDNVRFEGAATTEPVEPEPVDPGEETPPVDEKEAKKEQKEAEKEEKEE

SEQ ID NO: 12 - protein, 524 aa, Paenibacillus polymyxa
VVHGQTAKTITIKVDTFKDRKPISPYIYGTNQDLAGDENMAARRLGGNRMTGYNWENNMSNAGSDWQHSSDNYLCSNGGLTQAECEKPGAVVTSFHDQSLKLGTYSLVTLPMAGYVAADGNGSVQESEAAPSARWNQVVNAKNAPFQLQPDLNDNYVYVDEFVHFLVNKYGTASTKAGVKGYALDNEPALWSHTHPRIHPEKVGAKELVDRSVSLSKAVKAIDAGAEVFGPVLYGFGAYKDLQTAPDWDSVKGNYSWFVDYYLDQMRLSSQVEGKRLLDVFDVHWYPEAMGGGIRITNEVGNDETKKARMQAPRTLWDPTYKEDSWIAQWFSEFLPILPRLKQSVDKYYPGTKLAMTEYSYGGENDISGGIAMTDVLGILGKNDVYMANYWKLKDGVNNYVSAAYKLYRNYDGKNSTFGDTSVSAQTSDIVNSSVHASVTNASDKELHLVVMNKSMDSAFDAQFDLSGAKTYISGKVWGFDKNSSQIKEAAPITQISGNRFTYTVPPLTAYHIVLTTGNDTSPV

SEQ ID NO: 13 - protein, 214 aa, Melanocarpus albomyces
ANGQSTRYWDCCKPSCGWRGKGPVNQPVYSCDANFQRIHDFDAVSGCEGGPAFSCADHSPWAINDNLSYGFAATALSGQTEESWCCACYALTFTSGPVAGKTMVVQSTSTGGDLGSNHFDLNIPGGGVGLFDGCTPQFGGLPGARYGGISSRQECDSFPEPLKPGCQWRFDWFQNADNPSFTFERVQCPEELVARTGCRRHDDGGFAVFKAPSA

SEQ ID NO: 14 - protein, 221 aa, Aspergillus oryzae
VPVNPEPDATSVENVALKTGSGDSQSDPIKADLEVKGQSALPFDVDCWAILCKGAPNVLQRVNEKTKNSNRDRSGANKGPFKDPQKWGIKALPPKNPSWSAQDFKSPEEYAFASSLQGGTNAILAPVNLASQNSQGGVLNGFYSANKVAQFDPSKPQQTKGTWFQITKFTGAAGPYCKALGSNDKSVCDKNKNIAGDWGFDPAKWAYQYDEKNNKFNYVGK

(19) United States
(12) Patent Application Publication
(10) Pub. No.: US 2024/0218300 A1
(43) Pub. Date: Jul. 4, 2024

(54) DETERGENT COMPOSITION WITH REDUCED POLYMER CONTENT

(71) Applicant: Novozymes A/S, Bagsvaerd (DK)

(72) Inventors: Yue Cai, Beijing (CN); Peiyu Li, Binhai (CN); Lise Munch Mikkelsen, Roedovre (DK); Henrik Lund, Copenhagen (DK)

(73) Assignee: Novozymes A/S, Bagsvaerd (DK)

(21) Appl. No.: 18/557,507

(22) PCT Filed: Mar. 15, 2022
(86) PCT No.: PCT/CN2022/080799

§ 371 Date: Oct. 26, 2023

(30) Foreign Application Priority Data
Mar. 26, 2021 (WO) PCT/CN2021/083222
Apr. 15, 2021 (WO) PCT/CN2021/087514

(51) Int. Cl. C11D 3/386; C11D 3/37; C11D 3/38

(52) U.S. Cl. CPC C11D 3/38645; C11D 3/3723; C11D 3/381; C11D 3/38636; C11D 2111/12

(57) ABSTRACT

The present invention concerns detergent compositions with reduced polymer content.

### REFERENCE TO A SEQUENCE LISTING

This application contains a Sequence Listing in computer readable form, which is incorporated herein by reference.

### FIELD OF THE INVENTION

The present invention concerns detergent compositions with improved sustainability where the level of polymer is reduced by use of polypeptide having cellulase activity, optionally in combination with a DNase.

### BACKGROUND OF INVENTION

The ability of a detergent to release dirt and keep dirt suspended is of considerable importance for its efficiency. Particulate soil that is not kept suspended by the detergent will redeposit on the fabric. It is known that redeposited soil often is more difficult to remove than the original soil, due in part to its smaller particle size. The ability of surfactants in the detergent to release dirt and keep it in suspension is often insufficient, and polymers are therefore added to the detergent. The addition of polymers assists in preventing greying, dinginess and yellowing of garments which obviously are care-abouts from the customer point of view.

However, polymers are often derived from petrochemical resources and have faced scrutiny due to environmental concerns, most of all for not being sustainable because they are from a non-renewable source and are poorly biodegradable or even persistent in the environment. It is desirable to provide alternatives that have an improved sustainability profile while maintaining compatibility with other detergent ingredients. In addition, the consumer benefits and performance effects must be maintained.

### SUMMARY OF THE INVENTION

Petrochemically derived polymers present in detergents are not sustainable because they are derived from a non-renewable source and are poorly biodegradable or even persistent in the environment. The inventors of the present invention have surprisingly found that more sustainable detergent compositions, i.e. detergent compositions with an improved sustainability profile, can be achieved by replacing polymers in detergents partly or even completely by addition of cellulase while maintaining the wash performance of the detergent. In addition to being produced from a renewable agricultural source, and in contrast to polymers, cellulases are naturally found in the environment and readily biodegradable.

The replacement of polymers with cellulase addresses the United Nations' Sustainable Development Goals, in particular Goal 12 “Responsible consumption and production”: replacing polymer with cellulase allows the detergent producer—and thus the end user—to move from a fossil feedstock to a renewable feedstock and reduce the volume of persistent chemicals emitted to the environment. Consequently, the invention discloses how cellulase can, partly or fully, replace polymer for reducing or removing redeposition of soil to an item during a wash cycle, thereby improving the sustainability profile of the detergent.

### Definitions

Bacterial: The term “bacterial” in relation to polypeptide (such as an enzyme, e.g. a cellulase) refers to a polypeptide encoded by and thus directly derivable from the genome of a bacteria, where such bacteria has not been genetically modified to encode said polypeptide, e.g. by introducing the encoding sequence in the genome by recombinant DNA technology. In the context of the present invention, the term “bacterial cellulase” or “polypeptide having cellulase activity obtained from a bacterial source” or “polypeptide is of bacterial origin” thus refers to a cellulase encoded by and thus directly derivable from the genome of a bacterial species, where the bacterial species has not been subjected to a genetic modification introducing recombinant DNA encoding said cellulase. Thus, the nucleotide sequence encoding the bacterial polypeptide having cellulase activity is a sequence naturally in the genetic background of a bacterial species. A sequence encoding a bacterial polypeptide having cellulase activity may also be referred to a wildtype cellulase (or parent cellulase). Bacterial polypeptide having cellulase activity includes recombinant produced wild types. In a further aspect, the invention provides polypeptides having cellulase activity, wherein said polypeptides are substantially homologous to a bacterial cellulase. In the context of the present invention, the term “substantially homologous” denotes a polypeptide having cellulase activity which is at least 80%, preferably at least 85%, more preferably at least 90%, more preferably at least 95%, even more preferably at least 96%, 97%, 98%, and most preferably at least 99% identical to the amino acid sequence of a selected bacterial cellulase.

Cellulase: The term “cellulase” means one or more (e.g., several) enzymes that hydrolyze a cellulosic material. The two terms “polypeptide having cellulase activity” and “cellulase” are used interchangeably. Cellulases may be selected from the group consisting of cellulases belonging to GH5, GH7, GH12, GH44, GH45, EC 3.2.1.4, EC 3.2.1.21, EC 3.2.1.91 and EC 3.2.1.172. Such enzymes include endoglucanase(s) (e.g. EC 3.2.1.4), cellobiohydrolase(s), beta-glucosidase(s), or combinations thereof.

Suitable cellulases include mono-component and mixtures of enzymes of bacterial or fungal origin. Chemically modified or protein engineered mutants are also contemplated. The cellulase may for example be a mono-component or a mixture of mono-component endo-1,4-beta-glucanase also referred to as endoglucanase.

Suitable cellulases include those from the genera Bacillus, Pseudomonas, Humicola, Myceliophthora, Fusarium, Thielavia, Trichoderma, and Acremonium. Exemplary cellulases include a fungal cellulase from Humicola insolens (U.S. Pat. No. 4,435,307) or from Trichoderma, e.g. T. reesei or T. viride. Other suitable cellulases are from Thielavia e.g. Thielavia terrestris as described in WO 96/29397 or the fungal cellulases produced from Myceliophthora thermophila and Fusarium oxysporum disclosed in U.S. Pat. Nos. 5,648,263, 5,691,178, 5,776,757, WO 89/09259 and WO 91/17244. Also relevant are cellulases from Bacillus as described in WO 02/099091 and JP 2000210081. Suitable cellulases are alkaline or neutral cellulases having care benefits. Examples of cellulases are described in EP 0 495 257, EP 0 531 372, WO 96/11262, WO 96/29397, WO 98/08940. Other examples are cellulase variants such as those described in WO 94/07998, EP 0 531 315, U.S. Pat. Nos. 5,457,046, 5,686,593, 5,763,254, WO 95/24471, WO 98/12307.

Other cellulases are endo-beta-1,4-glucanase enzyme having a sequence of at least 97% identity to the amino acid sequence of position 1 to position 773 of SEQ ID NO:2 of WO 2002/099091 or a family 44 xyloglucanase, which a xyloglucanase enzyme having a sequence of at least 60% identity to positions 40-559 of SEQ ID NO: 2 of WO 2001/062903.

Commercially available cellulases include Carezyme®, Carezyme® Premium, Celluzyme®, Celluclean®, Celluclast®, Endolase®, Renozyme®; Whitezyme® Celluclean® Classic, Cellusoft® (Novozymes A/S), Puradax®, Puradax HA, and Puradax EG; Revitalenz 1000; Revitalenz 200; Revitalenz 2000 (Dupont Industrial Biosciences), KAC-500(B)™ (Kao Corporation), Biotouch DCL; Biotouch FLX1 (AB enzymes).

The two basic approaches for measuring cellulolytic enzyme activity include: (1) measuring the total cellulolytic enzyme activity, and (2) measuring the individual cellulolytic enzyme activities (endoglucanases, cellobiohydrolases, and beta-glucosidases) as reviewed in Zhang et al., 2006, Biotechnology Advances 24: 452-481. Total cellulolytic enzyme activity can be measured using insoluble substrates, including Whatman N^{o} 1 filter paper, microcrystalline cellulose, bacterial cellulose, algal cellulose, cotton, pretreated lignocellulose, etc. The most common total cellulolytic activity assay is the filter paper assay using Whatman N^{o} 1 filter paper as the substrate. The assay was established by the International Union of Pure and Applied Chemistry (IUPAC) (Ghose, 1987, Pure Appl. Chem. 59: 257-68).

Color difference (L value): A Lab color space is a color-opponent space with dimension L for lightness. L value, L* represents the darkest black at L*=0, and the brightest white at L*=100. In the context of the present invention L value is also referred to as color difference.

Detergent adjunct ingredient: The precise nature of these additional adjunct components, and levels of incorporation thereof, will depend on the physical form of the composition and the nature of the operation for which it is to be used. Suitable adjunct materials include, but are not limited to the components described below such as surfactants, builders, flocculating aid, chelating agents, dye transfer inhibitors, enzymes, enzyme stabilizers, enzyme inhibitors, catalytic materials, bleach activators, hydrogen peroxide, sources of hydrogen peroxide, preformed peracids, s, s, brighteners, suds suppressors, dyes, perfumes, structure elasticizing agents, fabric softeners, carriers, hydrotropes, builders and co-builders, fabric hueing agents, anti-foaming agents, dispersants, processing aids, solvents, and/or pigments.

Detergent composition: The term “detergent composition” refers to compositions that find use in the removal of undesired compounds from items to be cleaned, such as textiles. The detergent composition may be used to e.g. clean textiles for both household cleaning and industrial cleaning. The terms encompass any materials/compounds selected for the particular type of cleaning composition desired and the form of the product (e.g., liquid, gel, powder, granulate, paste, bar, or spray compositions) and includes, but is not limited to, detergent compositions (e.g., liquid and/or solid laundry detergents and fine fabric detergents; fabric fresheners; fabric softeners; laundry boosters; and textile and laundry pre-spotters/pre-treatment). In addition to containing the enzyme of the invention, the detergent formulation may contain one or more additional enzymes (such as proteases, amylases, lipases, cutinases, cellulases, endoglucanases, xyloglucanases, pectinases, pectin lyases, xanthanases, peroxidases, haloperoxygenases, catalases and mannanases, or any mixture thereof), and/or detergent adjunct ingredients such as surfactants, builders, chelators or chelating agents, bleach system or bleach components, polymers (as set forth herein), fabric conditioners, foam boosters, suds suppressors, dyes, perfume, tannish inhibitors, optical brighteners, bactericides, fungicides, soil suspending agents, anti-corrosion agents, enzyme inhibitors or stabilizers, enzyme activators, bluing agents and fluorescent dyes, antioxidants, and solubilizers.

Enzyme detergency benefit: The term “enzyme detergency benefit” is defined herein as the advantageous effect an enzyme may add to a detergent compared to the same detergent without the enzyme. Important detergency benefits which can be provided by enzymes are stain removal with no or very little visible soils after washing and/or cleaning, prevention or reduction of redeposition of soils released in the washing process (an effect that also is termed anti-redeposition), restoring fully or partly the whiteness of textiles which originally were white but after repeated use and wash have obtained a greyish or yellowish appearance (an effect that also is termed whitening). Also included is the maintenance of whiteness, e.g., the prevention of greying or dullness. Textile care benefits, which are not directly related to catalytic stain removal or prevention of redeposition of soils, are also important for enzyme detergency benefits. Examples of such textile care benefits are prevention or reduction of dye transfer from one fabric to another fabric or another part of the same fabric (an effect that is also termed dye transfer inhibition or anti-backstaining), removal of protruding or broken fibers from a fabric surface to decrease pilling tendencies or remove already existing pills or fuzz (an effect that also is termed anti-pilling), improvement of the fabric-softness, colour clarification of the fabric and removal of particulate soils which are trapped in the fibers of the fabric or garment. Enzymatic bleaching is a further enzyme detergency benefit where the catalytic activity generally is used to catalyze the formation of bleaching components such as hydrogen peroxide or other peroxides.

Fragment: The term “fragment” means a polypeptide having one or more (e.g., several) amino acids absent from the amino and/or carboxyl terminus of a mature polypeptide or domain; wherein the fragment has cellulase activity.

Fungal: In the context of the present invention the term “fungal” in relation to polypeptide (such as an enzyme, e.g. a cellulase) refers to a polypeptide encoded by and thus directly derivable from the genome of a fungus, where such fungus has not been genetically modified to encode said polypeptide, e.g. by introducing the encoding sequence in the genome by recombinant DNA technology. In the context of the present invention, the term “fungal cellulase” or “polypeptide having cellulase activity obtained from a fungal source” thus refers to a cellulase encoded by and thus directly derivable from the genome of a fungal species, where the fungal species has not been subjected to a genetic modification introducing recombinant DNA encoding said cellulase. Thus, the nucleotide sequence encoding the fungal polypeptide having cellulase activity is a sequence naturally in the genetic background of a fungal species. The fungal polypeptide having cellulase activity encoding by such sequence may also be referred to a wildtype cellulase (or parent cellulase). In a further aspect, the invention provides polypeptides having cellulase activity, wherein said polypeptides are substantially homologous to a fungal cellulase. In the context of the present invention, the term “substantially homologous” denotes a polypeptide having cellulase activity which is at least 80%, preferably at least 85%, more preferably at least 90%, more preferably at least 95%, even more preferably at least 96%, 97%, 98%, and most preferably at least 99% identical to the amino acid sequence of a selected fungal cellulase. The polypeptides being substantially homologous to a fungal cellulase may be included in the detergent of the present invention and/or be used in the methods of the present invention.

Host cell: The term “host cell” means any cell type that is susceptible to transformation, transfection, transduction, or the like with a nucleic acid construct or expression vector comprising a polynucleotide of the present invention. The term “host cell” encompasses any progeny of a parent cell that is not identical to the parent cell due to mutations that occur during replication.

Improved wash performance: The term “improved wash performance” is defined herein as an enzyme displaying an increased wash performance in a detergent composition relative to the wash performance of same detergent composition without the enzyme e.g. by increased stain removal or less redeposition. The term “improved wash performance” includes wash performance in laundry.

Isolated: The term “isolated” means a substance in a form or environment that does not occur in nature. Non-limiting examples of isolated substances include (1) any non-naturally occurring substance, (2) any substance including, but not limited to, any enzyme, variant, nucleic acid, protein, peptide or cofactor, that is at least partially removed from one or more or all of the naturally occurring constituents with which it is associated in nature; (3) any substance modified by the hand of man relative to that substance found in nature; or (4) any substance modified by increasing the amount of the substance relative to other components with which it is naturally associated (e.g., recombinant production in a host cell; multiple copies of a gene encoding the substance; and use of a stronger promoter than the promoter naturally associated with the gene encoding the substance). An isolated substance may be present in a fermentation broth sample; e.g. a host cell may be genetically modified to express the polypeptide of the invention. The fermentation broth from that host cell will comprise the isolated polypeptide.

Laundering: The term “laundering” relates to both household laundering and industrial laundering and means the process of treating textiles with a solution containing a cleaning or detergent composition of the present invention. The laundering process can for example be carried out using e.g. a household or an industrial washing machine or can be carried out by hand.

Mature polypeptide: The term “mature polypeptide” means a polypeptide in its final form following translation and any post-translational modifications, such as N-terminal processing, C-terminal truncation, glycosylation, phosphorylation, etc.

Mature polypeptide coding sequence: The term “mature polypeptide coding sequence” means a polynucleotide that encodes a mature polypeptide having cellulase activity.

Nucleic acid construct: The term “nucleic acid construct” means a nucleic acid molecule, either single- or double-stranded, which is isolated from a naturally occurring gene or is modified to contain segments of nucleic acids in a manner that would not otherwise exist in nature or which is synthetic, which comprises one or more control sequences.

Operably linked: The term “operably linked” means a configuration in which a control sequence is placed at an appropriate position relative to the coding sequence of a polynucleotide such that the control sequence directs expression of the coding sequence.

Sequence identity: The relatedness between two amino acid sequences or between two nucleotide sequences is described by the parameter “sequence identity”. For purposes of the present invention, the sequence identity between two amino acid sequences is determined using the Needleman-Wunsch algorithm (Needleman and Wunsch, 1970, J. Mol. Biol. 48: 443-453) as implemented in the Needle program of the EMBOSS package (EMBOSS: The European Molecular Biology Open Software Suite, Rice et al., 2000, Trends Genet. 16: 276-277), preferably version 5.0.0 or later. The parameters used are gap open penalty of 10, gap extension penalty of 0.5, and the EBLOSUM62 (EMBOSS version of BLOSUM62) substitution matrix. The output of Needle labeled “longest identity” (obtained using the -nobrief option) is used as the percent identity and is calculated as follows:

(Identical Residues×100)/(Length of Alignment−Total Number of Gaps in Alignment)

For purposes of the present invention, the sequence identity between two deoxyribonucleotide sequences is determined using the Needleman-Wunsch algorithm (Needleman and Wunsch, 1970, supra) as implemented in the Needle program of the EMBOSS package (EMBOSS: The European Molecular Biology Open Software Suite, Rice et al., 2000, supra), preferably version 5.0.0 or later. The parameters used are gap open penalty of 10, gap extension penalty of 0.5, and the EDNAFULL (EMBOSS version of NCBI NUC4.4) substitution matrix. The output of Needle labeled “longest identity” (obtained using the -nobrief option) is used as the percent identity and is calculated as follows:

(Identical Deoxyribonucleotides×100)/(Length of Alignment−Total Number of Gaps in Alignment).

Sustainability: Sustainability and sustainable means use of renewable resources that cause little or no damage to the environment and are biodegradable.

Sustainability profile: In the context of the present invention the term sustainability profile is used for comparing the sustainability of ingredients (e.g. in a detergent composition) where one or more ingredients can replace other less sustainable ingredients while maintaining the performance of the system (e.g. the performance of a detergent composition during wash of an item).

Textile: The term “textile” means any textile material including yarns, yarn intermediates, fibers, non-woven materials, natural materials, synthetic materials, and any other textile material, fabrics made of these materials and products made from fabrics (e.g., garments and other articles). The textile or fabric may be in the form of knits, wovens, denims, non-wovens, felts, yarns, and toweling. The textile may be cellulose based such as natural cellulosics, including cotton, flax/linen, jute, ramie, sisal or coir or manmade cellulosics (e.g. originating from wood pulp) including viscose/rayon, cellulose acetate fibers (tricell), lyocell or blends thereof. The textile or fabric may also be non-cellulose based such as natural polymers including wool, camel, cashmere, mohair, rabbit and silk or synthetic polymers such as nylon, aramid, polyester, acrylic, polypropylene and spandex/elastane, or blends thereof as well as blends of cellulose based and non-cellulose based fibers. Examples of blends are blends of cotton and/or rayon/viscose with one or more companion material such as wool, synthetic fiber (e.g. polyamide fiber, acrylic fiber, polyester fiber, polyvinyl chloride fiber, polyurethane fiber, polyurea fiber, aramid fiber), and/or cellulose-containing fiber (e.g. rayon/viscose, ramie, flax/linen, jute, cellulose acetate fiber, lyocell). Fabric may be conventional washable laundry, for example stained household laundry. When the term fabric or garment is used it is intended to include the broader term textiles as well. In the context of the present invention, the term “textile” also covers fabrics. In the context of the present invention, the term “textile” is used interchangeably with fabric and cloth.

Used or worn: The term “used or worn” used herein about a textile means that textile that has been used or worn by a consumer or has been in touch with human skin e.g. during manufacturing or retailing. A consumer can be a person that buys the textile, e.g. a person buying a textile (e.g. new clothes or bedlinen) in a shop or a business that buys the textile (e.g. bed linen, tea towel or table cloth) for use in the business e.g. a hotel, a restaurant, a professional kitchen, an institution, a hospital or the like. In some situations, such used or worn textile bear the conventional stains which has not been thoroughly washed out and can form a gluing base for attracting and accumulating more airborne particulate matter.

Variant: The term “variant” means a polypeptide having same activity as the parent enzyme comprising an alteration, i.e., a substitution, insertion, and/or deletion, at one or more (e.g., several) positions. A substitution means replacement of the amino acid occupying a position with a different amino acid; a deletion means removal of the amino acid occupying a position; and an insertion means adding an amino acid adjacent to and immediately following the amino acid occupying a position. In the context of the present invention, a variant of an identified cellulase has the enzymatic activity of the parent, i.e. the capacity of catalyzing the hydrolytic cleavage of phosphodiester linkages in the DNA backbone (deoxyribonuclease activity). In one embodiment, the deoxyribonuclease activity of the variant is increased with reference to the parent cellulase, e.g. the mature polypeptide of SEQ ID NO: 2.

Wash cycle: The term “wash cycle” is defined herein as a washing operation wherein textiles are immersed in the wash liquor, mechanical action of some kind is applied to the textile in order to release stains and to facilitate flow of wash liquor in and out of the textile and finally the superfluous wash liquor is removed. After one or more wash cycles, the textile is generally rinsed and dried.

Wash liquor: The term “wash liquor” is defined herein as the solution or mixture of water and detergent components optionally including the enzyme invention.

Wash performance: The term “wash performance” is used as detergent composition's, enzyme's or polymer's capability to remove stains present on the object to be cleaned or maintain color and whiteness of textile during wash. The improvement in the wash performance may be quantified by calculating the so-called delta REM (remission) as described in Experimental section.

Weight percentage: is abbreviated w/w %, wt % or w %. The abbreviations are used interchangeably.

Whiteness: The term “Whiteness” is defined herein as a broad term with different meanings in different regions and for different consumers. Whiteness can be on white textiles or be used interchangely as brightness for colored textiles. Loss of whiteness or brightness can e.g. be due to greying, yellowing, or removal of optical brighteners/hueing agents. Greying and yellowing can be due to soil redeposition, stain redeposition, dirt/mud redeposition, pollution particles, body soils, colouring from e.g. iron and copper ions or dye transfer. Loss of whiteness might include one or several issues from the list below: colourant or dye effects; incomplete stain removal (e.g. body soils, sebum etc.); redeposition (greying, yellowing or other discolourations of the object) (removed soils reassociate with other parts of textile, soiled or unsoiled); chemical changes in textile during application; and clarification or brightening of colours.

### Sequence Overview

SEQ ID NO: 1 is a DNase obtained from Aspergillus oryzae.
SEQ ID NO: 2 is a DNase obtained from Bacillus licheniformis.
SEQ ID NO: 3 is a DNase obtained from Bacillus subtilis.
SEQ ID NO: 4 is a DNase obtained from Serratia marcescens.
SEQ ID NO: 5 is a DNase obtained from Bacillus idriensis.
SEQ ID NO: 6 is a DNase isolated from Bacillus cibi.
SEQ ID NO: 7 is a DNase obtained from Bacillus horikoshii.
SEQ ID NO: 8 is a DNase obtained from Bacillus sp.
SEQ ID NO: 9 is a DNase obtained from Bacillus sp.
SEQ ID NO: 10 is a cellulase obtained from Humicola insolens.
SEQ ID NO: 11 is a cellulase obtained from Bacillus akibai.
SEQ ID NO: 12 is a cellulase obtained from Paenibacillus polymyxa.
SEQ ID NO: 13 is a cellulase obtained from Melanocarpus albomyces.
SEQ ID NO: 14 is a DNase obtained from Aspergillus oryzae

### DETAILED DESCRIPTION OF THE INVENTION

The inventors of the present invention have surprisingly found that more sustainable detergent compositions, i.e. detergent compositions with an improved sustainability profile, can be achieved by replacing ethoxylated poly(ethyleneimine) polymers in detergents partly or even completely by addition of cellulase while maintaining the wash performance of the detergent. In addition to being produced from a renewable agricultural source and in contrast to polymers, cellulases are naturally found in the environment and readily biodegradable. Particularly cellulases may replace ethoxylated poly(ethyleneimine) polymers found in liquid and powder detergent systems while still preventing the deposition of particles on garments during wash, even in the absence of typical ethoxylated poly(ethyleneimine) polymers.

As demonstrated in the Example section, while ethoxylated poly(ethyleneimine) polymers show benefit on textile in wash, cellulases can show competitive benefit, thus improving the sustainability profile.

Accordingly, in an embodiment the present invention is directed to a detergent composition with improved sustainability profile comprising a polypeptide having cellulase activity, an ethoxylated poly(ethyleneimine) polymer and at least one detergent adjunct ingredient, wherein the ratio (w/w) of ethoxylated poly(ethyleneimine) polymer to formulated cellulase is in the range 0.5 to 20; such as 0.5 to 10; such as 0.5 to 5; such as 0.5 to 2.5; such as 0.5 to 1.

In another embodiment the present invention is directed to a detergent composition with improved sustainability profile comprising a polypeptide having cellulase activity, an ethoxylated poly(ethyleneimine) polymer in the range 0-1.5% (w/w) and at least one detergent adjunct ingredient, wherein the formulated cellulase is added in amounts in the 0.05-0.5% (w/w); 0.1-0.5% (w/w); 0.15-0.5% (w/w); or 0.3-0.5% (w/w).

In another embodiment the present invention is directed to a detergent composition with improved sustainability profile comprising a polypeptide having cellulase activity, an ethoxylated poly(ethyleneimine) polymer and at least one detergent adjunct ingredient, wherein the ratio (w/w) between ethoxylated poly(ethyleneimine) polymer and polypeptide have cellulase activity (active enzyme protein) is in the range 0-20, such as 2-20, 5-20, 5-15, 5-10, such as 5, 6, 7, 8, 9 or 10.

In another embodiment, the present invention concerns the use of a polypeptide having cellulase activity for improvement of the sustainability profile of a detergent composition by maintaining or improving the wash performance of the detergent while at the same time reducing the level of ethoxylated poly(ethyleneimine) polymer.

In another embodiment, the present invention concerns the use of a polypeptide having cellulase activity for improvement of the sustainability profile of a detergent composition by removing soil from a textile and/or reduce redeposition of a soil to a textile during a wash cycle conducted, while at the same time reducing the level of ethoxylated poly(ethyleneimine) polymer. When the soil does not adhere to the item, the textile appears cleaner.

In one embodiment the present invention is directed to a detergent composition with improved sustainability profile comprising a polypeptide having cellulase activity and at least one detergent adjunct ingredient, wherein the composition comprises 2% or less, e.g. in the range 1.5-0.5% by weight of an ethoxylated poly(ethyleneimine) polymer. Preferably the composition comprises about 1% by weight of an ethoxylated poly(ethyleneimine) polymer, such as 1.2-0.8% by weight of an ethoxylated poly(ethyleneimine) polymer, preferably 1.1-0.9% by weight of an ethoxylated poly(ethyleneimine) polymer.

The invention further concerns a method for laundering an item, which method comprises the steps of:
a) exposing an item to a wash liquor comprising a polypeptide having cellulase activity or a detergent composition comprising the polypeptide and a reduced level of ethoxylated poly(ethyleneimine) polymer;
b) completing at least one wash cycle;
c) optionally adding additional soiling; and
d) optionally rinsing the item,
wherein the item is a textile.
   In an embodiment, the laundering method with the polypeptide having cellulase activity provides the same or better whiteness of the item compared to a laundering method performed with a detergent composition without cellulase but including a higher amount of ethoxylated poly(ethyleneimine) polymer.

The pH at 25° C. of the liquid solution is in the range of 1 to 11, such as in the range 5.5 to 11, such as in the range of 7 to 9, in the range of 7 to 8 or in the range of 7 to 8.5. The pH of a powder detergent may be measured as 1 g/L in demineralized water and is preferably in the range of 1-12; such as 5.5-11.5; such as 7.5-11.5; such as 8-11.

The wash liquor may have a temperature in the range of 5° C. to 95° C., or in the range of 10° C. to 80° C., in the range of 10° C. to 70° C., in the range of 10° C. to 60° C., in the range of 10° C. to 50° C., in the range of 15° C. to 40° C. or in the range of 20° C. to 40° C. In one embodiment the temperature of the wash liquor is 30° C.

In one embodiment of the invention, the method for laundering an item further comprises draining of the wash liquor or part of the wash liquor after completion of a wash cycle. The wash liquor can then be re-used in a subsequent wash cycle or in a subsequent rinse cycle. The item may be exposed to the wash liquor during a first and optionally a second or a third wash cycle. In one embodiment the item is rinsed after being exposed to the wash liquor. The item can be rinsed with water or with water comprising a conditioner.

A cellulase suitable for use as described in the present application is preferably a microbial cellulase, such as a Bacillus or fungal cellulase.

In an embodiment, the polypeptide having cellulase activity is obtained from Humicola in particular Humicola insolens. In an embodiment, cellulase comprises the amino acid sequence of SEQ ID NO: 10 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO 10. In one aspect, the polypeptides differ by up to 10 amino acids, e.g., 1, 2, 3, 4, 5, 6, 7, 8, 9, or 10, from the polypeptide comprising SEQ ID NO: 10.

In an embodiment, the polypeptide having cellulase activity is obtained from Bacillus, in particular Bacillus akibai. In an embodiment, the cellulase comprises the amino acid sequence of SEQ ID NO: 11 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO 11. In one aspect, the polypeptides differ by up to 10 amino acids, e.g., 1, 2, 3, 4, 5, 6, 7, 8, 9, or 10, from the polypeptide comprising SEQ ID NO: 11.

In an embodiment, the polypeptide having cellulase activity is obtained from Paenibacillus in particular Paenibacillus polymyxa. In an embodiment, the cellulase comprises the amino acid sequence of SEQ ID NO: 12 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO:12. In one aspect, the polypeptides differ by up to 10 amino acids, e.g., 1, 2, 3, 4, 5, 6, 7, 8, 9, or 10, from the polypeptide comprising SEQ ID NO: 12.

In an embodiment, the polypeptide having cellulase activity is obtained from Melanocarpus in particular Melanocarpus albomyces. In an embodiment, the cellulase comprises the amino acid sequence of SEQ ID NO: 13 or comprises an amino acid sequence having at least 60%, e.g., at least 65%, at least 70%, at least 75%, at least 80%, at least 85%, at least 90%, at least 91%, at least 92%, at least 93%, at least 94%, at least 95%, at least 96%, at least 97%, at least 98%, at least 99%, or 100% sequence identity to the polypeptide of SEQ ID NO:13. In one aspect, the polypeptides differ by up to 10 amino acids, e.g., 1, 2, 3, 4, 5, 6, 7, 8, 9, or 10, from the polypeptide comprising SEQ ID NO: 13.

The polypeptide having cellulase activity according to the present invention may be present in a detergent composition in an amount corresponding to at least 0.00002% active enzyme protein as weight percent of the detergent composition, preferably at least 0.000005%, 0.000001%, 0.00005%, 0.00001%, 0.0005%, 0.0001%, 0.005%, 0.001%, 0.002%, 0.003%, 0.004%, 0.005%, 0.006%, 0.008%, 0.01%, 0.02%, 0.03%, 0.05%, 0.1%, 0.2%, 0.3%, 0.4%, 0.6%, 0.7%, 0.8%, 0.9% or 1.0% of active cellulase protein as weight percent of the detergent composition.

The polypeptide having cellulase activity according to the present invention can be added as formulated enzyme in an amount between 0.05% to 10% as weight percent of the detergent composition. The polypeptide having cellulase activity as well as the DNase can be added as formulated enzyme in an amount between 0.05% to 5%, such as 0.05% to 3%, such as 0.05%, 0.075%, 0.1%, 0.15% 0.2%, 0.25%, 0.3%, 0.35%, 0.4%, 0.45%, 0.5%, 0.6%, 0.7%, 0.8%, 0.9%, 1%, 1.5%, 2%, 2.5%, 3%, 3.5%, 4%, 4.5%, 5%, 5.5%, 6%, 6.5%, 7%, 7.5%, 8%, 8.5%, 9%, or 9.5% or even 10% as weight percent of the detergent composition.

In an embodiment, the polypeptide having cellulase activity of SEQ ID NO: 10 or the polypeptide having cellulase activity of SEQ ID NO: 11, SEQ ID NO: 12, or SEQ ID NO: 13 comprises a substitution, deletion, and/or insertion at one or more (e.g., several) positions. In an embodiment, the number of amino acid substitutions, deletions and/or insertions introduced into the polypeptide SEQ ID NO: 10 or the polypeptide having cellulase activity of SEQ ID NO: 11, SEQ ID NO: 12, or SEQ ID NO: 13 is not more than 10, e.g., 1, 2, 3, 4, 5, 6, 7, 8 or 9. The amino acid changes may be of a minor nature, that is conservative amino acid substitutions or insertions that do not significantly affect the folding and/or activity of the protein; small deletions, typically of 1-30 amino acids; small amino- or carboxyl-terminal extensions, such as an amino-terminal methionine residue; a small linker peptide of up to 20-25 residues; or a small extension that facilitates purification by changing net charge or another function, such as a poly-histidine tract, an antigenic epitope or a binding domain.

Examples of conservative substitutions are within the groups of basic amino acids (arginine, lysine and histidine), acidic amino acids (glutamic acid and aspartic acid), polar amino acids (glutamine and asparagine), hydrophobic amino acids (leucine, isoleucine and valine), aromatic amino acids (phenylalanine, tryptophan and tyrosine), and small amino acids (glycine, alanine, serine, threonine and methionine). Amino acid substitutions that do not generally alter specific activity are known in the art and are described, for example, by H. Neurath and R. L. Hill, 1979, In, The Proteins, Academic Press, New York. Common substitutions are Ala/Ser, Val/lle, Asp/Glu, Thr/Ser, Ala/Gly, Ala/Thr, Ser/Asn, Ala/Val, Ser/Gly, Tyr/Phe, Ala/Pro, Lys/Arg, Asp/Asn, Leu/lle, Leu/Val, Ala/Glu, and Asp/Gly.

Alternatively, the amino acid changes are of such a nature that the physico-chemical properties of the polypeptides are altered. For example, amino acid changes may improve the thermal stability of the polypeptide, alter the substrate specificity, change the pH optimum, and the like.

Essential amino acids in a polypeptide can be identified according to procedures known in the art, such as site-directed mutagenesis or alanine-scanning mutagenesis (Cunningham and Wells, 1989, Science 244: 1081-1085). In the latter technique, single alanine mutations are introduced at every residue in the molecule, and the resultant mutant molecules are tested for enzyme activity to identify amino acid residues that are critical to the activity of the molecule. See also, Hilton et al., 1996, J. Biol. Chem. 271: 4699-4708. The active site of the enzyme or other biological interaction can also be determined by physical analysis of structure, as determined by such techniques as nuclear magnetic resonance, crystallography, electron diffraction, or photoaffinity labelling, in conjunction with mutation of putative contact site amino acids. See, for example, de Vos et al., 1992, Science 255: 306-312; Smith et al., 1992, J. Mol. Biol. 224: 899-904; Wlodaver et al., 1992, FEBS Lett. 309: 59-64. The identity of essential amino acids can also be inferred from an alignment with a related polypeptide.

Single or multiple amino acid substitutions, deletions, and/or insertions can be made and tested using known methods of mutagenesis, recombination, and/or shuffling, followed by a relevant screening procedure, such as those disclosed by Reidhaar-Olson and Sauer, 1988, Science 241: 53-57; Bowie and Sauer, 1989, Proc. Natl. Acad. Sci. USA 86: 2152-2156; WO 95/17413; or WO 95/22625. Other methods that can be used include error-prone PCR, phage display (e.g., Lowman et al., 1991, Biochemistry 30: 10832-10837; U.S. Pat. No. 5,223,409; WO 92/06204), and region-directed mutagenesis (Derbyshire et al., 1986, Gene 46: 145; Ner et al., 1988, DNA 7: 127).

Mutagenesis/shuffling methods can be combined with high-throughput, automated screening methods to detect activity of cloned, mutagenized polypeptides expressed by host cells (Ness et al., 1999, Nature Biotechnology 17: 893-896). Mutagenized DNA molecules that encode active polypeptides can be recovered from the host cells and rapidly sequenced using standard methods in the art. These methods allow the rapid determination of the importance of individual amino acid residues in a polypeptide.

The polypeptide may be a hybrid polypeptide in which a region of one polypeptide is fused at the N-terminus or the C-terminus of a region of another polypeptide.

The polypeptide may be a fusion polypeptide or cleavable fusion polypeptide in which another polypeptide is fused at the N-terminus or the C-terminus of the polypeptide of the present invention. A fusion polypeptide is produced by fusing a polynucleotide encoding another polypeptide to a polynucleotide of the present invention. Techniques for producing fusion polypeptides are known in the art and include ligating the coding sequences encoding the polypeptides so that they are in frame and that expression of the fusion polypeptide is under control of the same promoter(s) and terminator. Fusion polypeptides may also be constructed using intein technology in which fusion polypeptides are created post-translationally (Cooper et al., 1993, EMBO J. 12: 2575-2583; Dawson et al., 1994, Science 266: 776-779).

The concentration of the enzymes (cellulase, DNase and other enzymes present) in the wash liquor is typically in the range of 0.00004-100 ppm enzyme protein, such as in the range of 0.00008-100, in the range of 0.0001-100, in the range of 0.0002-100, in the range of 0.0004-100, in the range of 0.0008-100, in the range of 0.001-100 ppm enzyme protein, 0.01-100 ppm enzyme protein, preferably 0.05-50 ppm enzyme protein, more preferably 0.1-50 ppm enzyme protein, more preferably 0.1-30 ppm enzyme protein, more preferably 0.5-20 ppm enzyme protein, and most preferably 0.5-10 ppm enzyme protein.

The enzymes (cellulase, DNase and other enzymes present) of the detergent composition of the invention may be stabilized using conventional stabilizing agents, e.g. a polyol such as propylene glycol or glycerol, a sugar or sugar alcohol, lactic acid, boric acid, or a boric acid derivative, e.g. an aromatic borate ester, or a phenyl boronic acid derivative such as 4-formylphenyl boronic acid, and the composition may be formulated as described in, for example, WO92/19709 and WO92/19708.

A polypeptide of the present invention may also be incorporated in the detergent formulations disclosed in WO97/07202, which is hereby incorporated by reference.

### Liquid Enzyme Formulations

The enzymes (cellulase, DNase and other enzymes present) may be formulated as a liquid enzyme formulation, which is generally a pourable composition, though it may also have a high viscosity. The physical appearance and properties of a liquid enzyme formulation may vary a lot—for example, they may have different viscosities (gel to water-like), be colored, not colored, clear, hazy, and even with solid particles like in slurries and suspensions. The minimum ingredients are the enzymes (cellulase, DNase and other enzymes present) and a solvent system to make it a liquid.

The solvent system may comprise water, polyols (such as glycerol, (mono, di, or tri) propylene glycol, (mono, di, or tri) ethylene glycol, sugar alcohol (e.g. sorbitol, mannitol, erythritol, dulcitol, inositol, xylitol or adonitol), polypropylene glycol, and/or polyethylene glycol), ethanol, sugars, and salts. Usually the solvent system also includes a preservation agent and/or other stabilizing agents.

A liquid enzyme formulation may be prepared by mixing a solvent system and an enzyme concentrate with a desired degree of purity (or enzyme particles to obtain a slurry/suspension).

In an embodiment, the liquid enzyme composition comprises:
(a) at least 0.01% w/w active enzyme protein,
(b) at least 0.5% w/w polyol,
(c) water, and
(d) optionally a preservation agent.

The enzymes (cellulase, DNase and other enzymes present) in the liquid composition of the invention may be stabilized using conventional stabilizing agents. Examples of stabilizing agents include, but are not limited to, sugars like glucose, fructose, sucrose, or trehalose; polyols like glycerol, propylene glycol; addition of salt to increase the ionic strength; divalent cations (e.g., Ca²⁺ or Mg²⁺); and enzyme inhibitors, enzyme substrates, or various polymers (e.g., PVP). Selecting the optimal pH for the formulation may be very important for enzyme stability. The optimal pH depends on the specific enzyme but is typically in the range of pH 4-9. In some cases, surfactants like nonionic surfactant (e.g., alcohol ethoxylates) can improve the physical stability of the enzyme formulations.

One embodiment of the invention relates to a composition comprising a cellulase, wherein the composition further comprises:
(i) a polyol, preferably selected from glycerol, (mono, di, or tri) propylene glycol, (mono, di, or tri) ethylene glycol, polyethylene glycol, sugar alcohols, sorbitol, mannitol, erythritol, dulcitol, inositol, xylitol and adonitol;
(ii) optionally an additional enzyme, preferably selected from protease, amylase, or lipase, DNAse; Mannanase;
(iii) optionally a surfactant, preferably selected from anionic and nonionic surfactants,
(iv) optionally a salt, divalent cation, polymer, or enzyme inhibitor;
(v) optionally having a pH in the range of pH 4-9; and
(vi) water.

Slurries or dispersions of enzymes are typically prepared by dispersing small particles of enzymes (e.g., spray-dried particles) in a liquid medium in which the enzyme is sparingly soluble, e.g., a liquid nonionic surfactant or a liquid polyethylene glycol. Powder can also be added to aqueous systems in an amount so not all go into solution (above the solubility limit). Another format is crystal suspensions which can also be aqueous liquids (see for example WO2019/002356). Another way to prepare such dispersion is by preparing water-in-oil emulsions, where the enzyme is in the water phase, and evaporate the water from the droplets. Such slurries/suspension can be physically stabilized (to reduce or avoid sedimentation) by addition of rheology modifiers, such as fumed silica or xanthan gum, typically to get a shear thinning rheology.

### Purity of Enzyme in Formulations

The enzymes (cellulase, DNase and other enzymes present) used in the above-mentioned enzyme formulations may be purified to any desired degree of purity. This includes high levels of purification, as achieved for example by using methods of crystallization—but also none or low levels of purification, as achieved for example by using crude fermentation broth, as described in WO 2001/025411, or in WO 2009/152176.

### Microorganisms

The enzyme formulations, as well as the detergent formulations described below, may comprise one or more microorganisms or microbes. Generally, any microorganism(s) may be used in the enzyme/detergent formulations in any suitable amount(s)/concentration(s). Microorganisms may be used as the only biologically active ingredient, but they may also be used in conjunction with one or more of the enzymes described above.

The purpose of adding the microorganism(s) may, for example, be to reduce malodor as described in WO 2012/112718. Other purposes could include in-situ production of desirable biological compounds, or inoculation/population of a locus with the microorganism(s) to competitively prevent other non-desirable microorganisms form populating the same locus (competitive exclusion).

The term “microorganism” generally means small organisms that are visible through a microscope. Microorganisms often exist as single cells or as colonies of cells. Some microorganisms may be multicellular. Microorganisms include prokaryotic (e.g., bacteria and archaea) and eukaryotic (e.g., some fungi, algae, protozoa) organisms. Examples of bacteria may be Gram-positive bacteria or Gram-negative bacteria. Example forms of bacteria include vegetative cells and endospores. Examples of fungi may be yeasts, molds and mushrooms. Example forms of fungi include hyphae and spores. Herein, viruses may be considered microorganisms.

Microorganisms may be recombinant or non-recombinant. In some examples, the microorganisms may produce various substances (e.g., enzymes) that are useful for inclusion in detergent compositions. Extracts from microorganisms or fractions from the extracts may be used in the detergents. Media in which microorganisms are cultivated or extracts or fractions from the media may also be used in detergents. In some examples, specific of the microorganisms, substances produced by the microorganisms, extracts, media, and fractions thereof, may be specifically excluded from the detergents. In some examples, the microorganisms, or substances produced by, or extracted from, the microorganisms, may activate, enhance, preserve, prolong, and the like, detergent activity or components contained with detergents.

Generally, microorganisms may be cultivated using methods known in the art. The microorganisms may then be processed or formulated in various ways. In some examples, the microorganisms may be desiccated (e.g., lyophilized). In some examples, the microorganisms may be encapsulated (e.g., spray drying). Many other treatments or formulations are possible. These treatments or preparations may facilitate retention of microorganism viability over time and/or in the presence of detergent components. In some examples, however, microorganisms in detergents may not be viable. The processed/formulated microorganisms may be added to detergents prior to, or at the time the detergents are used.

In one embodiment, the microorganism is a species of Bacillus, for example, at least one species of Bacillus selected from the group consisting of Bacillus subtilis, Bacillus amyloliquefaciens, Bacillus licheniformis, Bacillus atrophaeus, Bacillus pumilus, Bacillus megaterium, or a combination thereof. In a preferred embodiment, the aforementioned Bacillus species are on an endospore form, which significantly improves the storage stability.

### Detergent Compositions

In one embodiment, the invention is directed to detergent compositions comprising a cellulase in combination with one or more additional cleaning composition components. In one embodiment, the detergent composition comprises a polypeptide having cellulase activity with an amino acid sequence having at least 60% identity, such as 70%, 80%, 90%, 95%, 96%, 97%, 98%, 99% or even 100% identity to the amino acid sequence set forth in SEQ ID NO: 10, SEQ ID NO: 11, SEQ ID NO: 12, or SEQ ID NO: 13. The detergent composition may comprise additional enzymes such as DNase with an amino acid sequence having at least 60% identity, such as 70%, 80%, 90%, 95%, 96%, 97%, 98%, 99% or even 100% identity to the amino acid sequences set forth in SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO:9, or SEQ ID NO: 14. In one embodiment the detergent composition is in solid form. In another embodiment, the detergent composition is in a liquid or gel form. In another embodiment a bar form. In one embodiment the detergent may be wrapped in water soluble PVOH film. The choice of additional components is within the skill of the artisan and includes conventional ingredients, including the exemplary non-limiting components set forth below.

### Liquid Detergent Composition

The liquid detergent composition may comprise a microcapsule of the invention, and thus form part of, any detergent composition in any form, such as liquid and powder detergents, and soap and detergent bars.

In one embodiment, the invention is directed to liquid detergent compositions comprising a microcapsule, as described above, in combination with one or more additional cleaning composition components.

The microcapsule, as described above, may be added to the liquid detergent composition in an amount corresponding to from 0.0001% to 5% (w/w) active enzyme protein (AEP); preferably from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

The liquid detergent composition has a physical form, which is not solid (or gas). It may be a pourable liquid, a paste, a pourable gel or a non-pourable gel. It may be either isotropic or structured, preferably isotropic. It may be a formulation useful for washing in automatic washing machines or for hand washing. It may also be a personal care product, such as a shampoo, toothpaste, or a hand soap.

The liquid detergent composition may be aqueous, typically containing at least 20% by weight and up to 95% water, such as up to 70% water, up to 50% water, up to 40% water, up to 30% water, or up to 20% water. Other types of liquids, including without limitation, alkanols, amines, diols, ethers and polyols may be included in an aqueous liquid detergent. An aqueous liquid detergent may contain from 0-30% organic solvent. A liquid detergent may even be non-aqueous, wherein the water content is below 10%, preferably below 5%.

Detergent ingredients can be separated physically from each other by compartments in water dissolvable pouches. Thereby negative storage interaction between components can be avoided. Different dissolution profiles of each of the compartments can also give rise to delayed dissolution of selected components in the wash solution.

The detergent composition may take the form of a unit dose product. A unit dose product is the packaging of a single dose in a non-reusable container. It is increasingly used in detergents for laundry. A detergent unit dose product is the packaging (e.g., in a pouch made from a water-soluble film) of the amount of detergent used for a single wash.

Pouches can be of any form, shape and material which is suitable for holding the composition, e.g., without allowing the release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water-soluble acrylate copolymers, methyl cellulose, carboxy methyl cellulose, sodium dextrin, ethyl cellulose, hydroxyethyl cellulose, hydroxypropyl methyl cellulose, maltodextrin, polymethacrylates, most preferably polyvinyl alcohol copolymers and, hydroxypropyl methyl cellulose (HPMC). Preferably the level of polymer in the film for example PVA is at least about 60%. Preferred average molecular weight will typically be about 20,000 to about 150,000. Films can also be a blend composition comprising hydrolytically degradable and water-soluble polymer blends such as polyactide and polyvinyl alcohol (known under the Trade reference M8630 as sold by Chris Craft In. Prod. Of Gary, Ind., US) plus plasticizers like glycerol, ethylene glycerol, Propylene glycol, sorbitol and mixtures thereof. The pouches can comprise a solid laundry cleaning composition or part components and/or a liquid cleaning composition or part components separated by the water-soluble film. The compartment for liquid components can be different in composition than compartments containing solids (see e.g., US 2009/0011970).

The choice of detergent components may include, for textile care, the consideration of the type of textile to be cleaned, the type and/or degree of soiling, the temperature at which cleaning is to take place, and the formulation of the detergent product. Although components mentioned below are categorized by general header according to a particular functionality, this is not to be construed as a limitation, as a component may comprise additional functionalities as will be appreciated by the skilled artisan.

The choice of additional components is within the skill of the artisan and includes conventional ingredients, including the exemplary non-limiting components set forth below.

### Pouches

Pouches can be configured as single or multicompartments. It can be of any form, shape and material which is suitable for hold the composition, e.g. without allowing the release of the composition to release of the composition from the pouch prior to water contact. The pouch is made from water soluble film which encloses an inner volume. Said inner volume can be divided into compartments of the pouch. Preferred films are polymeric materials preferably polymers which are formed into a film or sheet. Preferred polymers, copolymers or derivates thereof are selected polyacrylates, and water soluble acrylate copolymers, methyl cellulose, carboxy methyl cellulose, sodium dextrin, ethyl cellulose, hydroxyethyl cellulose, hydroxypropyl methyl cellulose, malto dextrin, poly methacrylates, most preferably polyvinyl alcohol copolymers and, hydroxypropyl methyl cellulose (HPMC).

### Surfactants

The cleaning composition may comprise one or more surfactants, which may be anionic and/or cationic and/or non-ionic and/or semi-polar and/or zwitterionic, or a mixture thereof. In a particular embodiment, the detergent composition includes a surfactant system (comprising more than one surfactant) e.g. a mixture of one or more nonionic surfactants and one or more anionic surfactants. In one embodiment the detergent comprises at least one anionic surfactant and at least one non-ionic surfactant, the weight ratio of anionic to nonionic surfactant may be from 20:1 to 1:20. Non-limiting examples of anionic surfactants include sulfates and sulfonates, typically available as sodium or potassium salts or salts of monoethanolamine (MEA, 2-aminoethan-1-ol) or triethanolamine (TEA, 2,2′,2″-nitrilotriethan-1-ol); in particular, linear alkylbenzenesulfonates (LAS), isomers of LAS such as branched alkylbenzenesulfonates (BABS) and phenylalkanesulfonates; olefin sulfonates, in particular alpha-olefinsulfonates (AOS); alkyl sulfates (AS), in particular fatty alcohol sulfates (FAS), i.e., primary alcohol sulfates (PAS) such as dodecyl sulfate (SLS); alcohol ethersulfates (AES or AEOS or FES, also known as alcohol ethoxysulfates or fatty alcohol ether sulfates); paraffin sulfonates (PS) including alkane-1-sulfonates and secondary alkanesulfonates (SAS); ester sulfonates, including sulfonated fatty acid glycerol esters and alpha-sulfo fatty acid methyl esters (alpha-SFMe or SES or MES); alkyl- or alkenylsuccinic acids such as dodecenyl/tetradecenyl succinic acid (DTSA); diesters and monoesters of sulfosuccinic acid; fatty acid derivatives of amino acids. Anionic surfactants may be added as acids, as salts or as ethanolamine derivatives.

Non-limiting examples of cationic surfactants include alkyldimethylethanolamine quat (ADMEAQ), cetyltrimethylammonium bromide (CTAB), dimethyldistearylammonium chloride (DSDMAC), and alkylbenzyldimethylammonium, alkyl quaternary ammonium compounds, alkoxylated quaternary ammonium (AQA) compounds, ester quats, and combinations thereof.

Non-limiting examples of nonionic surfactants include alcohol ethoxylates (AE or AEO) e.g. the AEO-series such as AEO-7, alcohol propoxylates, in particular propoxylated fatty alcohols (PFA), ethoxylated and propoxylated alcohols, alkoxylated fatty acid alkyl esters, such as ethoxylated and/or propoxylated fatty acid alkyl esters (in particular methyl ester ethoxylates, MEE), alkylpolyglycosides (APG), alkoxylated amines, fatty acid monoethanolamides (FAM), fatty acid diethanolamides (FADA), ethoxylated fatty acid monoethanolamides (EFAM), propoxylated fatty acid monoethanolamides (PFAM), polyhydroxyalkyl fatty acid amides, or N-acyl N-alkyl derivatives of glucosamine (glucamides, GA, or fatty acid glucamides, FAGA), as well as products available under the trade names SPAN and TWEEN, and combinations thereof.

Non-limiting examples of semipolar surfactants include amine oxides (AO) such as alkyldimethylamine oxides, in particular N-(coco alkyl)-N,N-dimethylamine oxide and N-(tallow-alkyl)-N, N-bis(2-hydroxyethyl)amine oxide, and combinations thereof.

Non-limiting examples of zwitterionic surfactants include betaines such as alkyldimethylbetaines, sulfobetaines, and combinations thereof.

Additional bio-based surfactants may be used e.g. wherein the surfactant is a sugar-based non-ionic surfactant which may be a hexyl-β-D-maltopyranoside, thiomaltopyranoside or a cyclic-maltopyranoside, such as described in EP2516606 B1. Other biosurfactants may include rhamnolipids and sophorolipids.

### Hydrotropes

A hydrotrope is a compound that solubilises hydrophobic compounds in aqueous solutions (or oppositely, polar substances in a non-polar environment). Typically, hydrotropes have both hydrophilic and a hydrophobic character (so-called amphiphilic properties as known from surfactants. Non-limiting examples of hydrotropes include sodium benzenesulfonate, sodium p-toluene sulfonate (STS), sodium xylene sulfonate (SXS), sodium cumene sulfonate (SCS), sodium cymene sulfonate, amine oxides, alcohols and polyglycolethers, sodium hydroxynaphthoate, sodium hydroxynaphthalene sulfonate, sodium ethylhexyl sulfate, and combinations thereof.

### Builders and Co-Builders

The detergent composition may contain about 0-65% by weight, such as about 5% to about 50% of a detergent builder or co-builder, or a mixture thereof. The builder and/or co-builder may particularly be a chelating agent that forms water-soluble complexes with Ca and Mg. Any builder and/or co-builder known in the art for use in cleaning detergents may be utilized.

Non-limiting examples of builders include zeolites, diphosphates (pyrophosphates), triphosphates such as sodium triphosphate (STP or STPP), carbonates such as sodium carbonate, soluble silicates such as sodium metasilicate, layered silicates (e.g., SKS-6 from Clariant), ethanolamines such as 2-aminoethan-1-ol (MEA), diethanolamine (DEA, also known as 2,2′-iminodiethan-1-ol), triethanolamine (TEA, also known as 2,2′,2″-nitrilotriethan-1-ol), and (carboxymethyl)inulin (CMI), and combinations thereof.

The detergent composition may also contain from about 0-50% by weight, such as about 5% to about 30%, of a detergent co-builder. The detergent composition may include a co-builder alone, or in combination with a builder, for example a zeolite builder. Non-limiting examples of co-builders include or copolymers thereof, such as poly(acrylic acid) (PAA) or copoly(acrylic acid/maleic acid) (PAA/PMA). Further non-limiting examples include citrate, chelators as such aminocarboxylates, aminopolycarboxylates and phosphonates, and alkyl- or alkenylsuccinic acid. Additional specific examples include 2,2′,2″-nitrilotriacetic acid (NTA), ethylenediaminetetraacetic acid (EDTA), diethylenetriaminepentaacetic acid (DTPA), iminodisuccinic acid (IDS), ethylenediamine-N,N′-disuccinic acid (EDDS), methylglycinediacetic acid (MGDA), glutamic acid-N,N-diacetic acid (GLDA), 1-hydroxyethane-1,1-diylbis(phosphonic acid (HEDP), ethylenediaminetetramethylenetetrakis(phosphonic acid) (EDTMPA), diethylenetriaminepentamethylenepentakis(phosphonic acid) (DTMPA or DTPMPA), N-(2-hydroxyethyl)iminodiacetic acid (EDG), aspartic acid-N-monoacetic acid (ASMA), aspartic acid-N,N-diacetic acid (ASDA), aspartic acid-N-monopropionic acid (ASMP), iminodisuccinic acid (IDA), N-(2-sulfomethyl)aspartic acid (SMAS), N-(2-sulfoethyl)aspartic acid (SEAS), N-(2-sulfomethyl)glutamic acid (SMGL), N-(2-sulfoethyl)glutamic acid (SEGL), N-methyliminodiacetic acid (MIDA), α-alanine-N,N-diacetic acid (α-ALDA), serine-N,N-diacetic acid (SEDA), isoserine-N,N-diacetic acid (ISDA), phenylalanine-N,N-diacetic acid (PHDA), anthranilic acid-N,N-diacetic acid (ANDA), sulfanilic acid-N,N-diacetic acid (SLDA), taurine-N,N-diacetic acid (TUDA) and sulfomethyl-N,N-diacetic acid (SMDA), N-(2-hydroxyethyl)ethylenediamine-N,N′,N″-triacetic acid (HEDTA), diethanolglycine (DEG), aminotrimethylenetris(phosphonic acid) (ATMP), and combinations and salts thereof. Further exemplary builders and/or co-builders are described in, e.g., WO 09/102854, U.S. Pat. No. 5,977,053.

### Polymers and Dispersants

Generally, detergent compositions may contain 0-10% by weight. Any polymer known in the art for use in detergents may be utilized. The polymer may function as a co-builder as mentioned above, or may provide anti-redeposition, fiber protection, soil release, dye transfer inhibition, grease cleaning and/or anti-foaming properties. Some polymers may have more than one of the above-mentioned properties and/or more than one of the below-mentioned motifs. Exemplary polymers include poly(vinyl alcohol) (PVA), poly(vinylpyrrolidone) (PVP), poly(ethyleneglycol) or poly(ethylene oxide) (PEG), ethoxylated poly(ethyleneimine), carboxymethyl inulin (CMI), and silicones, copolymers of terephthalic acid and oligomeric glycols, copolymers of poly(ethylene terephthalate) and poly(oxyethene terephthalate) (PET-POET), PVP, poly(vinylimidazole) (PVI), poly(vinylpyridine-N-oxide) (PVPO or PVPNO) and polyvinylpyrrolidone-vinylimidazole (PVPVI). Further exemplary polymers include polyethylene oxide and polypropylene oxide (PEO-PPO), diquaternium ethoxy sulfate, styrene/acrylic copolymer and perfume capsules Other exemplary polymers are disclosed in, e.g., WO 2006/130575. Salts of the above-mentioned polymers are also contemplated.

According to the present invention, however, certain of the above polymers, namely, a polyacrylic acid, a modified polyacrylic acid polymer, a modified polyacrylic acid copolymer, a maleic acid-acrylic acid copolymer, carboxymethyl cellulose, cellulose gum, methyl cellulose, and/or combinations thereof, can be included in lower levels than in currently available detergent compositions, or even more preferably, excluded altogether.

### Fabric Hueing Agents

The detergent compositions of the present invention may also include fabric hueing agents such as dyes or pigments, which when formulated in detergent compositions can deposit onto a fabric when said fabric is contacted with a wash liquor comprising said detergent compositions and thus altering the tint of said fabric through absorption/reflection of visible light. The composition may comprise from 0.0001 wt % to 0.2 wt % fabric hueing agent, this may be especially preferred when the composition is in the form of a unit dose pouch. Suitable hueing agents are also disclosed in, e.g. WO 2007/087257 and WO2007/087243.

### Additional Enzymes

The detergent additive as well as the detergent composition may comprise one or more additional enzymes e.g. additional protease, lipase, cutinase, an amylase, carbohydrase, DNase, pectinase, mannanase, arabinase, galactanase, xylanase, oxidase, e.g., a laccase, and/or peroxidase.

In general, the properties of the selected enzyme(s) should be compatible with the selected detergent, (i.e., pH-optimum, compatibility with other enzymatic and non-enzymatic ingredients, etc.), and the enzyme(s) should be present in effective amounts.

### DNase (Deoxyribonuclease)

The term “DNase” means a polypeptide with DNase activity that catalyzes the hydrolytic cleavage of phosphodiester linkages in the DNA backbone, thus degrading DNA. For purposes of the present invention, DNase activity is determined according to the procedure described in the Assay I.

Preferably the DNase is a polypeptide comprising the amino acid sequences having at least 60% identity, such as at least 65%, at least 70%, at least 75%, at least 80%, at least 81%, at least 82%, at least 83%, at least 84%, at least 85%, at least 90%, at least 91%, at least 92%, at least 93%, at least 94%, at least 95%, at least 96%, at least 97%, at least 98%, at least 99%, or even 100% sequence identity to any of the polypeptides of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9, or SEQ ID NO: 14.

### Mannanases

Suitable mannanases include those of bacterial or fungal origin. Chemically or genetically modified mutants are included. The mannanase may be an alkaline mannanase of Family 5 or 26. It may be a wild-type from Bacillus or Humicola, particularly B. agaradhaerens, B. licheniformis, B. halodurans, B. clausii, or H. insolens. Suitable mannanases are described in WO 1999/064619. A commercially available mannanase is Mannaway (Novozymes A/S).

### Proteases

Suitable proteases may be of any origin, but are preferably of bacterial or fungal origin, optionally in the form of protein engineered or chemically modified mutants. The protease may be an alkaline protease, such as a serine protease or a metalloprotease. A serine protease may for example be of the S1 family, such as trypsin, or the S8 family such as a subtilisin. A metalloprotease may for example be a thermolysin, e.g. from the M4 family, or another metalloprotease such as those from the M5, M7 or M8 families.

The term “subtilases” refers to a sub-group of serine proteases according to Siezen et al., Protein Eng. 4 (1991) 719-737 and Siezen et al., Protein Sci. 6 (1997) 501-523. Serine proteases are a subgroup of proteases characterized by having a serine in the active site, which forms a covalent adduct with the substrate. The subtilases may be divided into six subdivisions, the Subtilisin family, the Thermitase family, the Proteinase K family, the Lantibiotic peptidase family, the Kexin family and the Pyrolysin family.

Although proteases suitable for detergent use may be obtained from a variety of organisms, including fungi such as Aspergillus, detergent proteases have generally been obtained from bacteria and in particular from Bacillus. Examples of Bacillus species from which subtilases have been derived include Bacillus lentus, Bacillus alkalophilus, Bacillus subtilis, Bacillus amyloliquefaciens, Bacillus licheniformis, Bacillus pumilus and Bacillus gibsonii. Particular subtilisins include subtilisin lentus, subtilisin Novo, subtilisin Carlsberg, subtilisin BPN′, subtilisin 309, subtilisin 147 and subtilisin 168 and e.g. protease PD138 (described in WO 93/18140). Other useful proteases are e.g. those described in WO 01/16285 and WO 02/16547.

Examples of trypsin-like proteases include the Fusarium protease described in WO 94/25583 and WO 2005/040372, and the chymotrypsin proteases derived from Cellumonas described in WO 2005/052161 and WO 2005/052146.

Examples of metalloproteases include the neutral metalloproteases described in WO 2007/044993 such as those derived from Bacillus amyloliquefaciens, as well as e.g. the metalloproteases described in WO 2015/158723 and WO 2016/075078.

Examples of useful proteases are the protease variants described in WO 89/06279 WO 92/19729, WO 96/34946, WO 98/20115, WO 98/20116, WO 99/11768, WO 01/44452, WO 03/006602, WO 2004/003186, WO 2004/041979, WO 2007/006305, WO 2011/036263, WO 2014/207227, WO 2016/087617 and WO 2016/174234.

Suitable commercially available protease enzymes include those sold under the trade names Alcalase®, Duralase™, Durazym™, Relase®, Relase® Ultra, Savinase®, Savinase® Ultra, Primase™, Polarzyme®, Kannase®, Liquanase®, Liquanase® Ultra, Ovozyme®, Coronase®, Coronase® Ultra, Blaze®, Blaze Evity® 100T, Blaze Evity® 125T, Blaze Evity® 150T, Blaze Evity® 200T, Neutrase®, Everlase®, Esperase®, Progress® Uno, Progress® In and Progress® Excel (Novozymes A/S), those sold under the tradename Maxatase™, Maxacal™, Maxapem®, Purafect® Ox, Purafect® OxP, Puramax®, FN2™, FN3™, FN4^{ex}™, Excellase®, Excellenz™ P1000, Excellenz™ P1250, Eraser™, Preferenz® P100, Purafect Prime, Preferenz P110™, Effectenz P1000™, Purafect®, Effectenz P1050™, Purafect® Ox, Effectenz™ P2000, Purafast™, Properase®, Opticlean™ and Optimase® (Danisco/DuPont), BLAP (sequence shown in FIG. 29 of U.S. Pat. No. 5,352,604) and variants hereof (Henkel AG), and KAP (Bacillus alkalophilus subtilisin) from Kao.

### Lipases and Cutinases

Suitable lipases and cutinases include those of bacterial or fungal origin. Chemically modified or protein engineered mutant enzymes are included. Examples include lipase from Thermomyces, e.g. from T. lanuginosus (previously named Humicola lanuginosa) as described in EP258068 and EP305216, cutinase from Humicola, e.g. H. insolens (WO96/13580), lipase from strains of Pseudomonas (some of these now renamed to Burkholderia), e.g. P. alcaligenes or P. pseudoalcaligenes (EP218272), P. cepacia (EP331376), P. sp. strain SD705 (WO95/06720 & WO96/27002), P. wisconsinensis (WO96/12012), GDSL-type Streptomyces lipases (WO10/065455), cutinase from Magnaporthe grisea (WO10/107560), cutinase from Pseudomonas mendocina (U.S. Pat. No. 5,389,536), lipase from Thermobifida fusca (WO11/084412), Geobacillus stearothermophilus lipase (WO11/084417), lipase from Bacillus subtilis (WO11/084599), and lipase from Streptomyces griseus (WO11/150157) and S. pristinaespiralis (WO12/137147).

Other examples are lipase variants such as those described in EP407225, WO92/05249, WO94/01541, WO94/25578, WO95/14783, WO95/30744, WO95/35381, WO95/22615, WO96/00292, WO97/04079, WO97/07202, WO00/34450, WO00/60063, WO01/92502, WO07/87508 and WO09/109500.

Preferred commercial lipase products include include Lipolase™, Lipex™; Lipolex™ and Lipoclean™ (Novozymes A/S), Lumafast (originally from Genencor) and Lipomax (originally from Gist-Brocades).

Still other examples are lipases sometimes referred to as acyltransferases or perhydrolases, e.g. acyltransferases with homology to Candida antarctica lipase A (WO10/111143), acyltransferase from Mycobacterium smegmatis (WO05/56782), perhydrolases from the CE 7 family (WO09/67279), and variants of the M. smegmatis perhydrolase in particular the S54V variant used in the commercial product Gentle Power Bleach from Huntsman Textile Effects Pte Ltd (WO10/100028).

### Amylases

Suitable amylases which can be used together with the enzyme/variant/blend of enzymes of the invention may be an alpha-amylase or a glucoamylase and may be of bacterial or fungal origin. Chemically modified or protein engineered mutants are included. Amylases include, for example, alpha-amylases obtained from Bacillus, e.g., a special strain of Bacillus licheniformis, described in more detail in GB 1,296,839.

Suitable amylases include amylases having SEQ ID NO: 2 in WO 95/10603 or variants having 90% sequence identity to SEQ ID NO: 3 thereof. Preferred variants are described in WO 94/02597, WO 94/18314, WO 97/43424 and SEQ ID NO: 4 of WO 99/019467, such as variants with substitutions in one or more of the following positions: 15, 23, 105, 106, 124, 128, 133, 154, 156, 178, 179, 181, 188, 190, 197, 201, 202, 207, 208, 209, 211, 243, 264, 304, 305, 391, 408, and 444.

Different suitable amylases include amylases having SEQ ID NO: 6 in WO 02/010355 or variants thereof having 90% sequence identity to SEQ ID NO: 6. Preferred variants of SEQ ID NO: 6 are those having a deletion in positions 181 and 182 and a substitution in position 193.

Other examples are amylase variants such as those described in WO9526397, WO9623874, WO9741213, WO0060060, WO0029560, WO9923211, WO9946399, WO0060059, WO9942567, US20080293607, WO10115028, WO2011/098531, WO2013/001078, WO2013/001087, WO2013063460, WO2014099523, WO2014164777, WO0114532.

Commercially available amylases are Amplify Prime™, DuramyI™, TermamyI™, FungamyI™, Stainzyme™, Stainzyme Plus™, Natalase™, Liquozyme X and BAN™ (from Novozymes A/S), and Rapidase™, Purastar™/Effectenz™, Powerase, Preferenz S1000, Preferenz S100 Preferenz S110 and Preferenz S210 (from Genencor International Inc./DuPont).

### Peroxidases/Oxidases

Suitable peroxidases/oxidases include those of plant, bacterial or fungal origin. Chemically modified or protein engineered mutants are included. Examples of useful peroxidases include peroxidases from Coprinus, e.g., from C. cinereus, and variants thereof as those described in WO 93/24618, WO 95/10602, and WO 98/15257. Commercially available peroxidases include Guardzyme™ (Novozymes A/S).

A suitable peroxidase is preferably a peroxidase enzyme comprised by the enzyme classification EC 1.11.1.7, as set out by the Nomenclature Committee of the International Union of Biochemistry and Molecular Biology (IUBMB), or any fragment derived therefrom, exhibiting peroxidase activity.

Suitable peroxidases also include a haloperoxidase enzyme, such as chloroperoxidase, bromoperoxidase and compounds exhibiting chloroperoxidase or bromoperoxidase activity. Haloperoxidases are classified according to their specificity for halide ions. Chloroperoxidases (E.C. 1.11.1.10) catalyze formation of hypochlorite from chloride ions. The haloperoxidase may be a chloroperoxidase. Preferably, the haloperoxidase is a vanadium haloperoxidase, i.e., a vanadate-containing haloperoxidase. In a preferred method the vanadate-containing haloperoxidase is combined with a source of chloride ion.

Suitable oxidases include, in particular, any laccase enzyme comprised by the enzyme classification EC 1.10.3.2, or any fragment derived therefrom exhibiting laccase activity, or a compound exhibiting a similar activity, such as a catechol oxidase (EC 1.10.3.1), an o-aminophenol oxidase (EC 1.10.3.4), or a bilirubin oxidase (EC 1.3.3.5).

Preferred laccase enzymes are enzymes of microbial origin. The enzymes may be derived from plants, bacteria or fungi (including filamentous fungi and yeasts).

Suitable examples from fungi include a laccase derivable from a strain of Aspergillus, Neurospora, e.g., N. crassa, Podospora, Botrytis, Collybia, Fomes, Lentinus, Pleurotus, Trametes, e.g., T. villosa and T. versicolor, Rhizoctonia, e.g., R. solani, Coprinopsis, e.g., C. cinerea, C. comatus, C. friesii, and C. plicatilis, Psathyrella, e.g., P. condelleana, Panaeolus, e.g., P. papilionaceus, Myceliophthora, e.g., M. thermophila, Schytalidium, e.g., S. thermophilum, Polyporus, e.g., P. pinsitus, Phlebia, e.g., P. radiata (WO 92/01046), or Coriolus, e.g., C. hirsutus (JP 2238885).

Suitable examples from bacteria include a laccase derivable from a strain of Bacillus.

A laccase derived from Coprinopsis or Myceliophthora is preferred; in particular a laccase derived from Coprinopsis cinerea, as disclosed in WO 97/08325; or from Myceliophthora thermophila, as disclosed in WO 95/33836.

### Other Materials

Any detergent components known in the art for use in detergents may also be utilized. Other optional detergent components include anti-corrosion agents, anti-shrink agents, anti-soil redeposition agents, anti-wrinkling agents, bactericides, binders, corrosion inhibitors, disintegrants/disintegration agents, dyes, enzyme stabilizers (including boric acid, borates, and/or polyols such as propylene glycol), fabric conditioners including clays, fillers/processing aids, fluorescent whitening agents/optical brighteners, foam boosters, foam (suds) regulators, perfumes, soil-suspending agents, softeners, suds suppressors, tarnish inhibitors, and wicking agents, either alone or in combination. Any ingredient known in the art for use in detergents may be utilized. The choice of such ingredients is well within the skill of the artisan.

### Dye Transfer Inhibiting Agents

The detergent compositions of the present invention may also include one or more dye transfer inhibiting agents. Suitable polymeric dye transfer inhibiting agents include, but are not limited to, polyvinylpyrrolidone polymers, polyamine N-oxide polymers, copolymers of N-vinylpyrrolidone and N-vinylimidazole, polyvinyloxazolidones and polyvinylimidazoles or mixtures thereof.

### Fluorescent Whitening Agent

The detergent compositions of the present invention may also contain additional components that may tint articles being cleaned, such as fluorescent whitening agent or optical brighteners. Where present the brightener is preferably at a level of about 0.01% to about 0.5%. Any fluorescent whitening agent suitable for use in a laundry detergent composition may be used in the composition of the present invention.

### Soil Release Polymers

The detergent compositions of the present invention may also include one or more soil release polymers which aid the removal of soils from fabrics such as cotton and polyester based fabrics, in particular the removal of hydrophobic soils from polyester based fabrics. The soil release polymers may for example be nonionic or anionic terephthalte based polymers, polyvinyl caprolactam and related copolymers, vinyl graft copolymers, polyester polyamides see for example Chapter 7 in Powdered Detergents, Surfactant science series volume 71, Marcel Dekker, Inc. Another type of soil release polymers are amphiphilic alkoxylated grease cleaning polymers comprising a core structure and a plurality of alkoxylate groups attached to that core structure. The core structure may comprise a polyalkylenimine structure or a polyalkanolamine structure as described in detail in WO 2009/087523 (hereby incorporated by reference). Furthermore, random graft co-polymers are suitable soil release polymers. Suitable graft co-polymers are described in more detail in WO 2007/138054, WO 2006/108856 and WO 2006/113314 (hereby incorporated by reference).

### Anti-Redeposition Agents

The detergent compositions of the present invention may also include one or more anti-redeposition agents such as carboxymethylcellulose (CMC), polyvinyl alcohol (PVA), polyoxyethylene and/or polyethyleneglycol (PEG), homopolymers of acrylic acid, copolymers of acrylic acid and maleic acid. The cellulose based polymers described under soil release polymers above may also function as anti-redeposition agents.

According to the present invention, however, certain of the above polymers, namely, a polyacrylic acid, a modified polyacrylic acid polymer, a modified polyacrylic acid copolymer, a maleic acid-acrylic acid copolymer, carboxymethyl cellulose, cellulose gum, methyl cellulose, and/or combinations thereof, can be included in lower levels than in currently available detergent compositions, or excluded altogether, thus improving the sustainability profile of the detergent composition.

### Rheology Modifiers

The detergent compositions of the present invention may also include one or more rheology modifiers, structurants or thickeners, as distinct from viscosity reducing agents. The rheology modifiers are selected from the group consisting of non-polymeric crystalline, hydroxy-functional materials, polymeric rheology modifiers which impart shear thinning characteristics to the aqueous liquid matrix of a liquid detergent composition. The rheology and viscosity of the detergent can be modified and adjusted by methods known in the art, for example as shown in EP 2169040.

Other suitable adjunct materials include, but are not limited to, anti-shrink agents, anti-wrinkling agents, bactericides, binders, carriers, dyes, enzyme stabilizers, fabric softeners, fillers, foam regulators, hydrotropes, perfumes, pigments, sod suppressors, solvents, and structurants for liquid detergents and/or structure elasticizing agents.

### Laundry Soap Bars

The cellulase of the invention may be added to laundry soap bars and used for hand washing laundry, fabrics and/or textiles. The term laundry soap bar includes laundry bars, soap bars, combo bars, syndet bars and detergent bars. The types of bar usually differ in the type of surfactant they contain, and the term laundry soap bar includes those containing soaps from fatty acids and/or synthetic soaps. The laundry soap bar has a physical form which is solid and not a liquid, gel or a powder at room temperature. The term solid is defined as a physical form which does not significantly change over time, i.e. if a solid object (e.g. laundry soap bar) is placed inside a container, the solid object does not change to fill the container it is placed in. The bar is a solid typically in bar form but can be in other solid shapes such as round or oval.

The laundry soap bar may contain one or more additional enzymes, protease inhibitors such as peptide aldehydes (or hydrosulfite adduct or hemiacetal adduct), boric acid, borate, borax and/or phenylboronic acid derivatives such as 4-formylphenylboronic acid, one or more soaps or synthetic surfactants, polyols such as glycerine, pH controlling compounds such as fatty acids, citric acid, acetic acid and/or formic acid, and/or a salt of a monovalent cation and an organic anion wherein the monovalent cation may be for example Na⁺, K⁺ or NH₄⁺ and the organic anion may be for example formate, acetate, citrate or lactate such that the salt of a monovalent cation and an organic anion may be, for example, sodium formate.

### Embodiments of the Invention

E1 A detergent composition comprising from 0.5% to 2% by weight of an ethoxylated poly(ethyleneimine) polymer, from 0.0001% to 5% (w/w) active enzyme protein of a polypeptide having cellulase activity, and optionally at least one additional enzyme, and a detergent adjunct ingredient.

E2 Detergent composition according to E1 comprising from 0.5 to 1.5%, such as 0.7 to 1.3%, such as 0.8 to 1.2% such as 0.9 to 1.1% by weight, preferably about 1% by weight, of an ethoxylated poly(ethyleneimine) polymer, from 0.0001% to 5% (w/w) active enzyme protein of a polypeptide having cellulase activity, and optionally at least one additional enzyme, and a detergent adjunct ingredient.

E3 Detergent composition according to E1 or E2 comprising from 0.001% to 1% (w/w) active enzyme protein of a polypeptide having cellulase activity.

E4 Detergent composition according to E1 to E3, wherein the polypeptide having cellulase activity is obtained from a fungal source, preferably Humicola insolens or Thielavia terrestris or a bacterial source, preferably alkaline Bacillus akibai or Paenibacillus polymyxa.

E5 Detergent composition according to any of E1 to E4 wherein the polypeptide having cellulase activity is selected from the group of cellulases belonging to glycoside hydrolase family 5 (GH5), glycoside hydrolase family 7 (GH7), glycoside hydrolase family 12 (GH12), glycoside hydrolase family 44 (GH44), glycoside hydrolase family 45 (GH45), EC 3.2.1.4, EC 3.2.1.21, EC 3.2.1.91 or EC 3.2.1.172

E6 Detergent composition according to E1, further comprising a deoxyribonuclease obtained from a fungal source, preferably Aspergillus, e.g., A. oryzae or from a bacterial source, preferably Bacillus, e.g. B. cibi.

E7 Detergent composition according to any of E1 to E5, wherein the polypeptide having cellulase activity has an amino acid sequence selected from the group consisting of SEQ ID NO: 10, SEQ ID NO: 11, SEQ ID NO: 12 and SEQ ID NO: 13, or a cellulase that has an amino acid sequence having at least 60%, at least 65%, at least 70%, at least 75%, at least 80%, at least 85%, at least 90%, at least 95%, at least 96%, at least 97%, at least 98%, or even at least 99% sequence identity to any of SEQ ID NO: 10, SEQ ID NO: 11, SEQ ID NO: 12 and SEQ ID NO: 13.

E8 Detergent composition according to E1 to E6, wherein the optionally at least one additional enzyme has an amino acid sequence selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14 or a polypeptide having at least 60%, at least 65%, at least 70%, at least 75%, at least 80%, at least 85%, at least 90%, at least 95%, at least 96%, at least 97%, at least 98%, or even at least 99% sequence identity thereto.

E9 Use of a polypeptide having cellulase activity for the improvement of the sustainability profile of a detergent composition,
wherein the polypeptide having cellulase activity, optionally in combination with at least one additional enzyme, improves the sustainability profile of said detergent composition,
wherein the sustainability profile of the detergent composition is improved when one or more ethoxylated poly(ethyleneimine) polymers of the detergent composition is replaced partly or fully by a biodegradable ingredient.

E10 The use according to E9, wherein the polypeptide having cellulase activity is selected from the group consisting of cellulases belonging to glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45), EC 3.2.1.4, EC 3.2.1.21, EC 3.2.1.91 and EC 3.2.1.172.

E11 The use according to E9 or E10, wherein the polypeptide having cellulase activity is obtained from a fungal source, preferably Humicola insolens or Thielavia terrestris or a bacterial source, preferably Bacillus akibai or Paenibacillus polymyxa.

E12 The use according to E9 or E10, wherein the polypeptide having cellulase activity has an amino acid sequence selected from the group consisting of SEQ ID NO: 10, SEQ ID NO: 11, SEQ ID NO: 12 and SEQ ID NO: 13, or a cellulase that has an amino acid sequence having at least 60%, at least 65%, at least 70%, at least 75%, at least 80%, at least 85%, at least 90%, at least 95%, at least 96%, at least 97%, at least 98%, or even at least 99% sequence identity to any of SEQ ID NO: 10, SEQ ID NO: 11, SEQ ID NO: 12 and SEQ ID NO: 13.

E13 The use according to any of E9 to E12, wherein the polypeptide having cellulase activity is in combination with at least one additional enzyme, wherein the at least one additional enzyme is selected from the group consisting of protease, amylase, deoxyribonuclease, lipase, xyloglucanase, cutinase, pectinase, pectin lyase, xanthanases, peroxidase, haloperoxygenases, catalase and mannanase.

E14 The use according to E9 or E13, wherein the additional enzyme is a deoxyribonuclease.

E15 The use according to E14, wherein the deoxyribonuclease is obtained from a fungal source, preferably Aspergillus, e.g., A. oryzae or from a bacterial source, preferably Bacillus, e.g. B. cibi.

E16 The use according to E14, wherein the deoxyribonuclease has an amino acid sequence selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14, or a deoxyribonuclease that has an amino acid sequence having at least 60%, at least 65%, at least 70%, at least 75%, at least 80%, at least 85%, at least 90%, at least 95%, or even at least 99% sequence identity to any of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14.

E17 The use according to any of E9 to E12, wherein the polypeptide having cellulase activity is present in the detergent composition in an amount corresponding to from 0.0001% to 5% (w/w) active enzyme protein.

E18 The use according to E17, wherein the polypeptide having cellulase activity is present in the detergent composition in an amount corresponding to from 0.001% to 1% (w/w) active enzyme.

E19 The use according to any of E9 or E13 to E16, wherein the at least one additional enzyme is present in the detergent composition in an amount corresponding to from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

E20 A method for the improvement of the sustainability profile of a detergent composition comprising replacing partly or fully ethoxylated poly(ethyleneimine) polymers of the detergent composition with a polypeptide having cellulase activity, optionally in combination with at least one additional enzyme, wherein the sustainability profile of the detergent composition is improved when one or more ethoxylated poly(ethyleneimine) polymers of the detergent composition is replaced partly or fully by a biodegradable ingredient.

E21 The method according to E20, wherein the polypeptide having cellulase activity is selected from the group consisting of cellulases belonging to glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45), EC 3.2.1.4, EC 3.2.1.21, EC 3.2.1.91 and EC 3.2.1.172.

E22 The method according to E20 or E21, wherein the polypeptide having cellulase activity is obtained from a fungal source, preferably Humicola insolens or Thielavia terrestris or a bacterial source, preferably Bacillus akibai or Paenibacillus polymyxa.

E23 The method according to E20 or E21, wherein the polypeptide having cellulase activity has an amino acid sequence selected from the group consisting of SEQ ID NO: 10, SEQ ID NO: 11, SEQ ID NO: 12 and SEQ ID NO: 13, or a cellulase that has an amino acid sequence having at least 60%, at least 65%, at least 70%, at least 75%, at least 80%, at least 85%, at least 90%, at least 95%, at least 96%, at least 97%, at least 98%, or even at least 99% sequence identity to any of SEQ ID NO: 10, SEQ ID NO: 11, SEQ ID NO: 12 and SEQ ID NO: 13.

E24 The method according to any of E20 to E23, wherein the polypeptide having cellulase activity is in combination with at least one additional enzyme, wherein the at least one additional enzyme is selected from the group consisting of protease, amylase, deoxyribonuclease, lipase, xyloglucanase, cutinase, pectinase, pectin lyase, xanthanases, peroxidase, haloperoxygenases, catalase and mannanase.

E25 The method according to E20 or E24, wherein the additional enzyme is a deoxyribonuclease.

E26 The method according to E25, wherein the deoxyribonuclease is obtained from a fungal source, preferably Aspergillus, e.g., A. oryzae or from a bacterial source, preferably Bacillus, e.g. B. cibi.

E27 The method according to E25, wherein the deoxyribonuclease has an amino acid sequence selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14, or a deoxyribonuclease that has an amino acid sequence having at least 60%, at least 65%, at least 70%, at least 75%, at least 80%, at least 85%, at least 90%, at least 95%, or even at least 99% sequence identity to any of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14.

E28 The method according to any of E20 to E23, wherein the polypeptide having cellulase activity is present in the detergent composition in an amount corresponding to from 0.0001% to 5% (w/w) active enzyme protein.

E29 The method according to E28, wherein the polypeptide having cellulase activity is present in the detergent composition in an amount corresponding to from 0.001% to 1% (w/w) active enzyme.

E30 The method according to any of E20 or E24 to E27, wherein the one or more optional additional enzyme is present in the detergent composition in an amount corresponding to from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

E31 The use according to any of E9 to E19 or the method according to any of E20-E30, wherein the detergent is for laundering of a textile, preferably a cellulose based textile or a blend of cellulose based and non-cellulose based textiles.

E32 The use or the method according to E31, wherein the cellulose based textile is selected from the group consisting of cotton, flax/linen, jute, ramie, sisal, coir, viscose, cellulose acetate fibers (tricell), lyocell and blends thereof.

E33 The use or the method according to E31, wherein the non-cellulose based textile is selected from acrylic, nylon, polyester and spandex.

### Detergent Compositions

The below mentioned ranges of detergent components are generally useful in the context of the low-polymer detergent compositions of the invention.

Composition 1: Liquid detergent

| Ingredient | Amount (in wt %) |
|---|---|
| Anionic detersive surfactant (such as alkyl benzene sulphonate, alkyl | from 0 wt % to 40 |
| ether sulphate, alpha-olefin sulphonate, methyl ester sulphonate and | wt % thereof) |
| mixtures) | |
| Non-ionic detersive surfactant (such as alkyl ethoxylated alcohol, | from 0 wt % to 40 |
| alkylpoly glucosides; Glycereth-6 Laurate, biosurfactants, and | wt % |
| mixtures) | |
| Other detersive surfactant (such as zwitterionic detersive surfactants, | from 0 wt % to 4 wt % |
| amphoteric surfactants, quaternary ammonium compounds and | |
| mixtures thereof) | |
| Carboxylate polymer (such as co-polymers of maleic acid and acrylic | from 0 wt % to 4 wt % |
| acid, add other PCA polymers, eg. Sokalan CP types, Acusol types, | |
| etc) | |
| Polyethylene glycol polymer (such as a polyethylene glycol polymer | from 0 wt % to 4 wt % |
| comprising poly vinyl acetate side chains, PEG/vinyl acetate co- | |
| polymer, e.g Sokalan HP22 type) | |
| Polyester or terephthalate soil release polymer (such as | From 0 to 4 wt % |
| Polypropylene/Polyethylene Terephthalate; Polyethylene | |
| Terephthalate; Sulfonated Polyethylene/Polyethylene Terephthalate | |
| anionic polyester, nonionic polymer, examples are the REPEL-O-TEX ® | |
| line of polymers (Solvay), including REPEL-O-TEX ® Crystal, REPEL- | |
| O-TEX ® SRP-6 and REPEL-O-TEX ® SF-2, Marloquest ® polymers, | |
| such as Marloquest ® SL (Sasol), and/or TexCare ® polymers, including | |
| TexCare@ SRA-300, TexCare ®, TexCare ® SRN-170, TexCare ® SRN- | |
| 240, TexCare@ SRN-260, and TexCare ® SRN-325, (Clariant). | |
| Other polymer (such as amine polymers, dye PVP-NO/Polyvinyl | from 0 wt % to 10 |
| Pyrrolidone N-oxide; Vinylpyrrolidone/vinylimidazole co-polymers, | wt % |
| hexamethylenediamine derivative polymers, Ethoxylated polyethylene- | |
| polyamine; AZIRIDIN, HOMOPOLYMER, and mixtures thereof, eg. | |
| Sokalan HP types, Sokalan K types | |
| Other builder (such as sodium citrate and/or citric acid, ethanolamine | from 0 wt % to 10 |
| (such as MEA, DEA and TEA) | wt % |
| Carbonate salt (such as sodium carbonate and/or sodium bicarbonate) | from 0 wt % to 10 |
| | wt % |
| Solvents (such as, 1,2-propanediol, glycerol and ethanol) | 0 wt % to 40 wt % |
| Chelant (such as the phosphonates and aminocarboxylates | from 0 wt % to2 wt % |
| (ethylenediamine-N′N′-disuccinic acid (EDDS) and/or hydroxyethane | |
| diphosphonic acid (HEDP), diethylenetriamine penta(methylene | |
| phosphonic acid) (DTPMP), Diethylenetriamine-pentaacetic acid | |
| (DTPA), Ethylenediaminetetraacetic acid (EDTA), methylglycine | |
| diacetic acid (MGDA); glutamic acid-N,N-diacetic acid (GLDA)) | |
| Optical brightener (such as 4,4′-Distyryl biphenyl types, FWA 5; FWA 7; | from 0 wt % to 0.5 |
| FWA 11 and the likes | wt % |
| Formulated protease/s | from 0 wt % to 5 wt % |
| Formulated Amylase/s | from 0 wt % to 1 wt % |
| Formulated Cellulase/s | from 0 wt % to 1 wt % |
| Formulated Lipase/s | from 0 to 1 wt % |
| Other formulated enzyme (such as xyloglucanase, cutinase, pectate | from 0 wt % to 2 wt % |
| lyase, mannanase, bleaching enzyme) | |
| Formulated DNase/s | 0.000001-10% |
| Fabric softener (such as montmorillonite clay and/or | from 0 wt % to 4 wt % |
| polydimethylsiloxane (PDMS) | |
| Suds suppressor (such as silicone and/or fatty acid) | from 0 wt % to |
| | 10 wt % |
| Perfume (such as perfume microcapsule, perfume extract, liquid | from 0 wt % to 1 wt % |
| perfume, and any combination thereof) | |
| Aesthetics (such as opacifiers and colorants) | from 0 wt % to 1 wt % |
| Preservatives (eg isothiazolinones, phenoxyethanol, etc) | From 0 wt % to 2 wt % |
| others | optional |
| Filler (such as water) | balance |

Composition 2: Unit Dose

| Ingredient | Amount (in wt %) |
|---|---|
| Anionic detersive surfactant (such as alkyl benzene sulphonate, alkyl | from 0 wt % to 50 |
| ether sulphate, alpha-olefin sulphonate, methyl ester sulphonate and | wt % thereof |
| mixtures, as acids, neutralized salts or as monoethanolamine adducts) | |
| Non-ionic detersive surfactant (such as alkyl ethoxylated alcohol, | from 0 wt % to 50 |
| alkylpoly glucosides; Glycereth-6 Laurate, biosurfactants and | wt % |
| mixtures) | |
| Other detersive surfactant (such as zwitterionic detersive surfactants, | from 0 wt % to 5 wt % |
| amphoteric surfactants, quaternary ammonium compounds and | |
| mixtures thereof) | |
| Carboxylate polymer (such as co-polymers of maleic acid and acrylic | from 0 wt % to 5 wt % |
| acid, add other PCA polymers, eg. Sokalan CP types, Acusol types, | |
| etc) | |
| Polyethylene glycol polymer (such as a polyethylene glycol polymer | from 0 wt % to 5 wt % |
| comprising poly vinyl acetate side chains, PEG/vinyl acetate co- | |
| polymer | |
| Eg Sokalan HP22 type) | |
| Polyester or terephthalate soil release polymer (such as | From 0 to 5 wt % |
| Polypropylene/Polyethylene Terephthalate; Polyethylene | |
| Terephthalate; Sulfonated Polyethylene/Polyethylene Terephthalate | |
| anionic polyester, nonionic polymer, examples are the REPEL-O-TEX ® | |
| line of polymers (Solvay), including REPEL-O-TEX ® Crystal, REPEL- | |
| O-TEX ® SRP-6 and REPEL-O-TEX ® SF-2, Marloquest ® polymers, | |
| such as Marloquest@ SL (Sasol), and/or TexCare ® polymers, including | |
| TexCare@ SRA-300, TexCare ®, TexCare ® SRN-170, TexCare ® SRN- | |
| 240, and TexCare ® SRN-325, (Clariant). | |
| Other polymer (such as amine polymers, dye transfer inhibitor | from 0 wt % to 20 |
| polymers, PVP-NO/Polyvinyl Pyrrolidone N-oxide; Vinylpyrrolidone/ | wt % |
| vinylimidazole co-polymers, hexamethylenediamine derivative | |
| polymers, Ethoxylated polyethylene-polyamine; AZIRIDIN, | |
| HOMOPOLYMER, and mixtures thereof, eg. Sokalan HP types, | |
| Sokalan K types | |
| Other builder (such as sodium citrate and/or citric acid, ethanolamine | from 0 wt % to 15 |
| (such as MEA, DEA and TEA) | wt % |
| Solvents (such as, 1,2-propanediol, 1,3-propanediol, glycerol, | 10 wt % to 60 wt % |
| dipropylene glycol, methylpropanediol, sorbitol and ethanol) | |
| Chelant (such as the phosphonates and aminocarboxylates | from 0 wt % to 4 wt % |
| (ethylenediamine-N′N′-disuccinic acid (EDDS) and/or hydroxyethane | |
| diphosphonic acid(HEDP), diethylenetriamine penta(methylene | |
| phosphonic acid) (DTPMP), Diethylenetriamine-pentaacetic acid | |
| (DTPA), Ethylenediaminetetraacetic acid (EDTA), methylglycine | |
| diacetic acid (MGDA); glutamic acid-N,N-diacetic acid (GLDA), as | |
| acids, neutralized salts or as monoethanolamine adducts) | |
| Optical brightener (such as 4,4′-Distyryl biphenyl types, FWA 5; FWA 7; | from 0 wt % to 2 wt % |
| FWA 11 and the likes) | |
| Formulated protease/s | from 0 wt % to 10 |
| | wt % |
| Formulated Amylase/s | from 0 wt % to |
| | 10 wt % |
| Formulated Cellulase/s | from 0 wt % to 5 wt % |
| Formulated Lipase/s | from 0 wt % to 5 wt % |
| Other formulated enzyme (such as xyloglucanase, cutinase, pectate | from 0 wt % to 5 wt % |
| lyase, mannanase, bleaching enzyme) | |
| Formulated DNase/s | 0.000001-10% |
| Fabric softener (such as montmorillonite clay and/or | from 0 wt % to 4 wt % |
| polydimethylsiloxane (PDMS) | |
| Suds suppressor (such as silicone and/or fatty acid (as acids, | from 0 wt % to |
| neutralized salts or as monoethanolamine adducts)) | 10 wt % |
| Perfume (such as perfume microcapsule, perfume extract, liquid | from 0 wt % to 5 wt % |
| perfume, and any combination thereof) | |
| Aesthetics (such as opacifiers and colorants) | from 0 wt % to 2 wt % |
| Preservatives (such as isothiazolinones, phenoxyethanol) | From 0 wt % to 2 wt % |
| water | From 2 wt % to 15 wt % |
| others | optional |
| Filler (such as solvents) | balance |

Composition 3 Powder detergent

| Ingredient | Amount (in wt %) |
|---|---|
| Anionic detersive surfactant (such as alkyl benzene sulphonate, alkyl | from 0 wt % to 30 |
| ether sulphate, alpha-olefin sulphonate, methyl ester sulphonate and | wt % thereof) |
| mixtures | |
| Non-ionic detersive surfactant (such as alkyl ethoxylated alcohol, | from 0 wt % to 10 |
| alkylpoly glucosides; Glycereth-6 Laurate, biosurfactants, and mixtures) | wt % |
| Other detersive surfactant (such as zwitterionic detersive surfactants, | from 0 wt % to 4 |
| amphoteric surfactants, quaternary ammonium compounds and | wt % |
| mixtures thereof) | |
| Carboxylate polymer (such as co-polymers of maleic acid and acrylic | from 0 wt % to 6 |
| acid, polyacrylate, polycarboxylate and other PCA polymers, eg. | wt % |
| Sokalan CP types, Acusol types, etc) | |
| Polyethylene glycol polymer (such as a polyethylene glycol polymer | from 0 wt % to 4 |
| comprising poly vinyl acetate side chains) | wt % |
| Polyester or terephthalate soil release polymer (such as | 0 to 2 wt % |
| Polypropylene/Polyethylene Terephthalate; Polyethylene | |
| Terephthalate; Sulfonated Polyethylene/Polyethylene Terephthalate | |
| anionic polyester, nonionic polymer, examples are the REPEL-O-TEX ® | |
| line of polymers (Solvay), including, REPEL-O-TEX ® SRP-6 and | |
| REPEL-O-TEX ® SF-2, Marloquest ® polymers, such as Marloquest ® | |
| SL (Sasol), and/or TexCare ® polymers like TexCare ® SRA 300 F | |
| (Clariant). | |
| Other polymer (such as amine polymers, dye PVP-NO/Polyvinyl | from 0 wt % to 10 |
| Pyrrolidone N-oxide; Vinylpyrrolidone/vinylimidazole co-polymers, | wt % |
| hexamethylenediamine derivative polymers, and mixtures thereof, e.g. | |
| Sokalan HP types, Sokalan K types | |
| Cellulosic polymer (such as carboxymethyl cellulose, cellulose gum, | from 0 wt % to 5 |
| methyl cellulose and combinations thereof) | wt % |
| Zeolite builder and phosphate builder (such as zeolite 4A and/or sodium | from 0 wt % to 50 |
| tripolyphosphate) | wt % |
| Other builder (such as sodium citrate and/or citric acid | from 0 wt % to 20 |
| | wt % |
| Carbonate salt (such as sodium carbonate and/or sodium bicarbonate) | from 0 wt % to 50 |
| | wt % |
| Silicate salt (such as sodium silicate) | from 0 wt % to 15 |
| | wt % |
| Source of available oxygen (such as sodium percarbonate) | from 0 wt % to 30 |
| | wt % |
| Bleach activator (such as tetraacetylethylene diamine (TAED) and/or | from 0 wt % to 15 |
| nonanoyloxybenzenesulphonate (NOBS) | wt % |
| Bleach catalyst (such as oxaziridinium-based bleach catalyst and/or | from 0 wt % to 0.5 |
| transition metal bleach catalyst) | wt % |
| Other bleach (such as reducing bleach and/or pre- formed peracid) | from 0 wt % to 10 |
| | wt % |
| Chelant (such as the phosphonates and aminocarboxylates | from 0 wt % to2 |
| (ethylenediamine-N′N′-disuccinic acid (EDDS) and/or hydroxyethane | wt % |
| diphosphonic acid (HEDP), diethylenetriamine penta(methylene | |
| phosphonic acid) (DTPMP), Diethylenetriamine-pentaacetic acid | |
| (DTPA), Ethylenediaminetetraacetic acid (EDTA), methylglycine | |
| diacetic acid (MGDA); glutamic acid-N,N-diacetic acid (GLDA)) | |
| Optical brightener (such as 4,4′-Distyryl biphenyl types, FWA 5; FWA 7; | from 0 wt % to 1 |
| FWA 11 and the likes | wt % |
| Photobleach (such as zinc and/or aluminium sulphonated | from 0 wt % to 0.5 |
| phthalocyanine) | wt % |
| Hueing agent (such as direct violet 99, acid red 52, acid blue 80, direct | from 0 wt % to 1 |
| violet 9, solvent violet 13 and any combination thereof) | wt % |
| Formulated protease/s | from 0 wt % to 5 |
| | wt % |
| Formulated Amylase/s | from 0 wt % to 1 |
| | wt % |
| Formulated Cellulase/s | from 0.05 wt % to 5 |
| | wt % |
| Formulated Lipase/s | from 0 to 1 wt % |
| Other formulated enzyme (such as xyloglucanase, cutinase, pectate | from 0 wt % to 2 |
| lyase, mannanase, bleaching enzyme) | wt % |
| Formulated DNase/s | from 0 wt % to 5 |
| | wt % |
| Fabric softener (such as montmorillonite clay and/or | from 0 wt % to 4 |
| polydimethylsiloxane (PDMS) | wt % |
| Flocculant (such as polyethylene oxide) | from 0 wt % to 1 |
| | wt % |
| Suds suppressor (such as silicone and/or fatty acid) | from 0 wt % to |
| | 5 wt % |
| Perfume (such as perfume microcapsule, spray-on perfume, starch | from 0 wt % to 1 |
| encapsulated perfume accords, perfume loaded zeolite, and any | wt % |
| combination thereof) | |
| Aesthetics (such as colorants) | from 0 wt % to 1 |
| | wt % |
| Miscellaneous | from 0-5% each |
| Filler (such as sodium sulphate, sodium chloride and/or bio-fillers and/or | balance |
| water/solvents) | |

Surfactant ingredients can be obtained from BASF, Ludwigshafen, Germany (Lutensol(R)); Shell Chemicals, London, UK; Stepan, Northfield, III, USA; Huntsman, Huntsman, Salt Lake City, Utah, USA; Clariant, Sulzbach, Germany (Praepagen(R)).

Sodium tripolyphosphate can be obtained from Rhodia, Paris, France. Zeolite can be obtained from Industrial Zeolite (UK) Ltd, Grays, Essex, UK. Citric acid and sodium citrate can be obtained from Jungbunzlauer, Basel, Switzerland. NOBSis sodium nonanoyloxybenzenesulfonate, supplied by Eastman, Batesville, Ark., USA.

TAED is tetraacetylethylenediamine, supplied under the Peractive(R) brand name by Clariant GmbH, Sulzbach, Germany.

Sodium carbonate and sodium bicarbonate can be obtained from Solvay, Brussels, Belgium.

Polyacrylate, polyacrylate/maleate copolymers can be obtained from BASF, Ludwigshafen, Germany.

Repel-O-Tex(R) can be obtained from Rhodia, Paris, France.

Texcare(R) can be obtained from Clariant, Sulzbach, Germany. Sodium percarbonate and sodium carbonate can be obtained from Solvay, Houston, Tex., USA.

Na salt of Ethylenediamine-N,N′-disuccinic acid, (S,S) isomer (EDDS) was supplied by Octel, Ellesmere Port, UK.

Hydroxy ethane di phosphonate (HEDP) was supplied by Dow Chemical, Midland, Mich., USA.

Enzymes Savinase(R), Savinase(R) Ultra, Stainzyme(R) Plus, Lipex(R), Lipolex(R), Lipoclean(R), Celluclean(R), Carezyme(R), Natalase(R), Stainzyme(R), Stainzyme(R) Plus, Termamyl(R), Termamyl(R) ultra, and Mannaway(R) can be obtained from Novozymes, Bagsvaerd, Denmark.

Enzymes Purafect(R), FN3, FN4 and Optisize can be obtained from Genencor International Inc., Palo Alto, California, US.

Direct violet 9 and 99 can be obtained from BASF DE, Ludwigshafen, Germany. Solvent violet 13 can be obtained from Ningbo Lixing Chemical Co., Ltd. Ningbo, Zhejiang, China. Brighteners can be obtained from Ciba Specialty Chemicals, Basel, Switzerland.

All percentages and ratios are calculated by weight unless otherwise indicated. All percentages and ratios are calculated based on active concentration of the total composition unless otherwise indicated.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Enzyme Assays

### Assay I: Testing of DNase Activity

DNase activity is determined on DNase Test Agar with Methyl Green (BD, Franklin Lakes, NJ, USA), prepared according to the manual from supplier. Briefly, 21 g of agar is dissolved in 500 ml water and then autoclaved for 15 min at 121° C. Autoclaved agar is temperated to 48° C. in water bath, and 20 ml of agar is poured into petridishes with and allowed to solidify by incubation o/n at room temperature. On solidified agar plates, 5 μl of enzyme solutions are added, and DNase activity are observed as colorless zones around the spotted enzyme solutions.

### Assay II: Testing of Cellulase Activity

Cellulase activity is determined as the ability of an enzyme to catalyze hydrolysis of 1,4-beta-D-glucosidic linkages in beta-1,4-glucan (cellulose). For purposes of the present invention, cellulase activity is determined using AZCL-HE-cellulose (from Megazyme) as the reaction substrate.

### EXAMPLES

A typical dosage of the ethoxylated poly(ethyleneimine) polymer in an EU or US detergent is about 4-5 wt %. In the following examples, the wash performance of partially for fully replacing the ethoxylated poly(ethyleneimine) polymer with a cellulase or a cellulase in combination with a DNase was investigated.

### Test Methods and Materials

### Test #1 Stain Removal Performance Evaluation by FSW Method

TABLE 1
Detergent Model A2

| | Model A2 (wt %) |
|---|---|
| Na-LAS | 12 |
| AEOS/SLES | 4 |
| AEO | 12 |
| Soap | 3 (palm kernel oil soap) |
| Sodium citrate | 3.9 |
| DTPMP Na7 | 1.5 |
| TEA | 2 |
| MPG | 2 |
| Ethanol | 3.1 |
| Phenoxyethanol | 0.5 |
| Demineralized water | adjust to 100 |

TABLE 2
AISE (International Association for Soaps, Detergents
and Maintenance Products) Stain swatch set

| Swatch No. | Name | Producer | Stain type |
|---|---|---|---|
| 1 | WE5LTWKC | Warwick-Equest | Tea |
| 2 | WE5ECWKC | Warwick-Equest | Coffee |
| 3 | WE5RWWKC | Warwick-Equest | Red wine |
| 4 | CS15 | Center For | Fruit juice |
| | | Testmaterials BV | |
| 5 | WE5TPWKC | Warwick-Equest | Tomato puree |
| 6 | WE5IACBFWKC | Warwick-Equest | Carrot baby food |
| 7 | WE5FSMWKC | Warwick-Equest | French squeezy |
| | | | mustard |
| 8 | CS44 | Center For | Chocolate |
| | | Testmaterials BV | |
| 9 | CS08 | Center For | Grass |
| | | Testmaterials BV | |
| 10 | WE5GMWKC | Warwick-Equest | Grass/Mud |
| 11 | WE5DASBWKC | Warwick-Equest | Blood |
| 12 | C01 | Center For | Unused motor oil |
| | | Testmaterials BV | |
| 13 | WE5BBWKC | Warwick-Equest | Cooked beef fat |
| 14 | CS17 | Center For | Makeup |
| | | Testmaterials BV | |

TABLE 3
FSW condition for stain removal test

| | |
|---|---|
| EU washing | Description |
| machine Miele | |
| WPS W5841 | |
| Wash program | Cotton/short |
| Water level | About 15.6 L with Water plus, standard EU |
| (water plus) | |
| Ballast | 4 kg total weight (including swatches) |
| | Mixed cotton/polyester ratio at 65/35 |
| Temperature | 40° C. |
| Wash time | 51 min main wash and 3 cycles of rinse |
| Water hardness | 15° dH. Ca²⁺/Mg²⁺/HCO₃⁻ |
| | Ca²⁺/Mg²⁺/HCO₃⁻ ratio 4:1:7.5 |
| Detergent | Detergent dose: 3.3 g/L of Model A2. With background |
| | enzyme 0.71% protease, 0.1% amylase, 0.05% |
| | mannanase. |
| On top | Enzymes of the invention, an ethoxylated |
| additions | poly(ethyleneimine) polymer, and/or others, referring to |
| | wt % of full detergent dose. |
| Test swatches | Stain swatch set is listed in above table 2, for each |
| | washing machine, 2 pieces of each swatch are used. |
| Soil | 8xSBL2004 sheets (purchased from CFT) |
| Repetition | 1 cycle wash, 6 repetitions |

The general FSW wash procedure instructions are as following:
a. Prepare the ballast and test swatches, and hard water with Ca/Mg according to desired water hardness.
b. Dissolve detergent in 1 L hardwater and stir for 30 min.
c. For a whiteness performance test, add red clay powder (100 mesh sieve filtrated) in 1 L detergent solution and stir for 10 min. Please note the red clay powder is sifted by 50 mesh sieves. For other wash tests (e.g. stain removal), skip this step c.
d. Add the test stains, soil ballast and ballast into washing machine drum.
e. Select parameters for the wash: Program, Water level and Temperature.
f. Press start button of machine to start water filling. Water consumption is registered automatically during this time.
g. Add in detergent-red clay mixture through detergent tank. Rinse the beaker with hard water and add rinse water into washing machine till all the clay powder is added into machine drum.
h. After the wash is completed, the test swatches are removed from the tea towels and placed on trays for drying.
i. Above procedure may be repeated for several times to mimic the graying/yellowish progress in real life condition.
j. Measure the remission at 460 nm of dried swatches/real items/tracers.

### Test #2 Whiteness Performance Evaluation by FSW Method

The general FSW wash procedure instructions are similar as that described in Test #1, detailed conditions and test materials are listed in below tables 4-8.

TABLE 4
FSW condition for EU HDL (heavy duty liquid) detergent

| | |
|---|---|
| EU washing | Description |
| machine Miele | |
| WPS W5841 | |
| Wash program | Cotton/short |
| Water level | About 15.6 L with Water plus, standard EU |
| (water plus) | |
| Ballast | 4 kg total weight (including swatches) |
| | Mixed cotton/polyester ratio at 65/35 |
| Temperature | 30° C. |
| Wash time | 51 min main wash and 3 cycles of rinse |
| Water hardness | 15° dH. Ca²⁺/Mg²⁺/HCO₃⁻ |
| | Ca²⁺/Mg²⁺/HCO₃⁻ ratio 4:1:7.5 |
| Detergent | Detergent dose: 3.3 g/L of Model A2. With |
| | background enzyme 0.8% protease, 0.1% amylase, |
| | 0.1% Mannanase |
| On top additions | Enzymes of the invention, ethoxylated |
| | poly(ethyleneimine) polymers, and/or others, |
| | referring to wt % of full detergent dose. |
| Test swatches | White tracer set listed in table 5 below, for each |
| | washing machine, 3 pieces of each tracer are used. |
| Soil | 8xSBL2004 sheets and red clay powder 2 g/L |
| Repetition | 6 cycles wash |

TABLE 5
White tracer set for EU wash test

| No. | Name | Producer | Fabric | Comments |
|---|---|---|---|---|
| 1 | W-10 A | CFT | WFK standard cotton | natural textile |
| 2 | W-12 A | CFT | Cotton terry | natural textile |
| 3 | W-80 A | CFT | knitted cotton | natural textile |
| 4 | C-N-11 | CFT | bleached woven cotton | natural textile |
| 5 | C-N-42 | CFT | Cotton interlock double jersey | natural textile |
| 6 | T-266 | CFT | Spun viscose challis | natural textile |
| 7 | T-7422 | CFT | Polyester/cotton 50/50 Jersey knit | mixed textile |
| | | | tubular | |
| 8 | P-C-N-01 | CFT | Polyester/cotton, 65/35, woven | mixed textile |
| 9 | W-20 A | CFT | Polyester/cotton, 65/35, woven | mixed textile |
| 10 | T-720 | CFT | Texturized dacron 56T, Double knit | Synthetic textile |
| | | | jersey (disperse dyeable) | |
| 11 | P-N-01 | CFT | Bleached woven polyester | Synthetic textile |
| 12 | W-30 A | CFT | polyester | Synthetic textile |
| 13 | W-40 A | CFT | Polyamid | Synthetic textile |
| 14 | T-340 Nylon/Lycra, | CFT | Nylon/Lycra, 81/19 | Synthetic textile |
| | 81/19 | | | |

TABLE 6
Model detergent J2.
J2 represents a typical US HDL detergent
and is included for US wash test.

| | Detergent J2 (wt %) |
|---|---|
| AEO | 5 |
| Coco tatty acid | 1.0 |
| AEOS | 14.18 |
| AS | 5.0 |
| LAS | 5.15 |
| DTPA | 0.25 |
| Sodium citrate | 4.0 |
| MEA | 0.30 |
| Ethanol | 1.5 |
| MPG | 3.0 |
| NaOH | 0.70 |
| Formate | 1.0 |
| Water | adjust to 100 |

TABLE 7
White tracer set for US wash test

| Swatch | | | | |
|---|---|---|---|---|
| No. | Name | Producer | Fabric | comments |
| 1 | CN-42 | CFT | Cotton interlock double | natural textile |
| | | | jersey | |
| 2 | W-80 A | CFT | knitted cotton | natural textile |
| 3 | CN-11 | CFT | bleached woven cotton | natural textile |
| 4 | W-10 A | CFT | WFK standard cotton | natural textile |
| 5 | W-12 A | CFT | Cotton terry | natural textile |
| 6 | T-266 | CFT | Spun viscose challis | natural textile |
| 7 | P-C-N-01 | CFT | Polyester/cotton, 65/35, | mixed textile |
| | | | woven | |
| 8 | W-20 A | CFT | Polyester/cotton, 65/35, | mixed textile |
| | | | woven | |
| 9 | T-7422 | CFT | Polyester/cotton 50/50 | mixed textile |
| | | | Jersey knit tubular | |
| 10 | W-27 A | CFT | Polyester/Cotton 65/35 | mixed textile |
| 11 | W-30 A | CFT | polyester | Synthetic textile |
| 12 | W-40 A | CFT | Polyamid | Synthetic textile |
| 13 | PAN-1 | CFT | Polyacryl | Synthetic textile |
| 14 | Decatholon | Decatholon | 100% polyester | Synthetic textile |
| | T-shirt | | | |
| 15 | PN-33 | CFT | 100% polyester crepe | Synthetic textile |

TABLE 8
FSW conditions for US wash test

| US washing | Description | |
|---|---|---|
| machine | | |
| Wash program | Normal, extra heavy | |
| Water level | 28 | L |
| (water plus) | | |
| Ballast | 3.6 kg ballast (65/35) | |
| Temperature | 25° | C. |

| | |
|---|---|
| Wash time | 16 min main wash and 1 cycle of rinse |
| Water hardness | 6° dH. Ca²⁺/Mg²⁺/HCO₃⁻ |
| | Ca²⁺/Mg²⁺/HCO₃⁻ ratio 2:1:4.5 |
| Detergent | Detergent dose: 1.8 g/L of Model J2. With background |
| | enzyme 0.8% protease, 0.1% amylase, 0.1% |
| | mannanase |
| On top | Enzymes of the invention, ethoxylated |
| additions | poly(ethyleneimine) polymers, and/or others, referring |
| | to wt % of full detergent dose. |
| Test swatches | White tracer set is listed in above table 7, for each |
| | washing machine, 3 pieces of each tracer are used. |
| Soil | 15xSBL2004 sheets and red clay powder 56 g/wash |
| Repetition | 6 cycles wash |

### Test #3 Whiteness Performance Evaluation by TOM Wash Test

The Tergo-To-Meter (TOM) is a medium scale model wash system that can be applied to test 16 different wash conditions simultaneously. A TOM is basically a large temperature-controlled water bath with up to 16 open metal beakers submerged into it. Each beaker constitutes one small top loader style washing machine and during an experiment, each of them will contain a solution of a specific detergent/enzyme/polymer system and the soiled and unsoiled fabrics its performance is tested on. Mechanical stress is achieved by a rotating stirring arm, which stirs the liquid within each beaker.

The TOM model wash system is mainly used in medium scale testing of detergents, enzymes and polymers at EU or AP wash conditions. In a TOM experiment, factors such as the ballast to soil ratio and the fabric to wash liquor ratio can be varied. Therefore, the TOM provides the link between small scale experiments, and the more time-consuming full-scale experiments.

Set temperature in the Terg-O-Tometer and start the rotation in the water bath. Wait for the temperature to adjust (tolerance is +/−0.5° C.). All beakers shall be clean and without traces of prior test material.

The wash solution with desired amount of detergent, temperature and water hardness is prepared in a bucket. The detergent is allowed to dissolve during magnet stirring for 10 min. Wash solution shall be used within 30 to 60 min after preparation.

1 L wash solution is added into a TOM beaker. The wash solution is agitated at 120 rpm and optionally one or more enzymes or polymers are added to the beaker. The swatches are sprinkled into the beaker and then the ballast load. Time measurement starts when the swatches and ballast are added to the beaker. The swatches are washed for 20 or 30 minutes after which agitation is terminated.

The wash load is subsequently transferred from the TOM beaker to a sieve and rinse with cold tap water. The swatches/tracers are separated from the ballast load and are transferred to a 5 L beaker with cold tap water under running water for 5 minutes. The water is gently pressed out of the swatches by hand and placed on a tray covered with a paper. The swatches are allowed to dry overnight before subjecting the swatches to analysis, such as measuring the delta REM.

In the present invention, the whiteness performance was further evaluated by TOM wash method with a representative EU Pod (or unit dose) form of detergent (i.e., Detergent U1). The test conditions and materials are listed in below tables 9-11.

TABLE 9
Ingredients of Detergent U1

| | U1 (wt %) |
|---|---|
| LAS (acid) | 21 |
| AEO | 25 |
| Palm kernel fatty acid | 9 |
| MPG | 15 |
| Glycerol (85%) | 8 |
| Water | 10 |
| MEA | 6.8 |
| DTMPA (42%) | 0.5 |
| Hole (incl. perfume, enzymes, | 4.7 |
| polymers) | |

TABLE 10
TOM wash condition

| Wash | 25° C., 1.8 g/L detergent U1, 15° dH, Ca2⁺/Mg2⁺/HCO3⁻ | |
|---|---|---|
| parameters | Ca2⁺/Mg2⁺/HCO3⁻ ratio 4:1:7.5 | |
| Wash cycle | 1 | |
| Water | 1 L/beaker | |
| volume | | |
| Rotation | 120 | rpm |
| Wash time | 60 | min |

| | |
|---|---|
| Soil ballast, | ½ SBL2004 + 4 g/L red clay powder (100 mesh |
| per beaker | sieve filtrated) |
| Tracer | White tracer set is listed in table 11 below. |
| swatch | 3 pieces of each tracer per beaker. |

TABLE 11
White tracer set for EU TOM wash test

| Swatch | | | | |
|---|---|---|---|---|
| No. | Name | Producer | Fabric | comments |
| 1 | CN-42 | CFT | Cotton | natural textile |
| | | | interlock | |
| | | | double jersey | |
| 2 | W-80 A | CFT | knitted cotton | natural textile |
| 3 | CN-11 | CFT | bleached | natural textile |
| | | | woven cotton | |
| 4 | T-266 | CFT | Spun viscose | natural textile |
| | | | challis | |
| 5 | P-CN-01 | CFT | Polyester/ | mixed textile |
| | | | cotton, 65/35, | |
| | | | woven | |
| 6 | W-20 A | CFT | Polyester/ | mixed textile |
| | | | cotton, 65/35, | |
| | | | woven | |
| 7 | T-7422 | CFT | Polyester/ | mixed textile |
| | | | cotton 50/50 | |
| | | | Jersey knit | |
| | | | tubular | |
| 8 | P-N-01 | CFT | Bleached | Synthetic textile |
| | | | woven | |
| | | | polyester | |
| 9 | Decatholon | Decatholon | 100% polyester | Synthetic textile |
| | T-shirt | | | |
| 10 | PN-33 | CFT | 100% polyester | Synthetic textile |
| | | | crepe | |

### Test #14 Anti-Dinginess Assessment on Real Items by FSW Under EU Wash Condition

TABLE 12
EU FSW conditions.
The FSW procedure instructions are similar as that described in Test#1.

| | |
|---|---|
| EU washing | Description |
| machine | |
| Miele WPS | |
| W5841 | |
| Wash program | Cotton/short |
| Water level | 15.6 L with Water plus, standard EU |
| (water plus) | |
| Ballast | 4 kg total weight (including swatches) |
| | Mixed cotton/polyester ratio at 65/35 |
| Temperature | 30° C. |
| Wash time | 51 min main wash and 3 cycles of rinse |
| Water hardness | 15° dH. Ca²⁺/Mg²⁺/HCO₃⁻ |
| | Ca²⁺/Mg²⁺/HCO₃⁻ ratio 4:1:7.5 |
| Detergent | Detergent dose: 3.3 g/L of Model A2. With background |
| | enzyme 0.71% protease, 0.1% amylase, 0.05% |
| | mannanase |
| On top | Enzymes of the invention, ethoxylated |
| additions | poly(ethyleneimine) polymers, and/or others, referring |
| | to wt % of full detergent dose. |
| Test swatches | White Collars, pillowcases and T- shirts were purchased |
| | from CN local company Fakai. Collars and T-shirt were |
| | worn by male workers for 3-5 days, pillowcases were |
| | used for one month before wash. Worn real items were |
| | cut into 2 equal pieces and washed by 2 conditions. For |
| | each washing machine, 10 pieces of ½ worn collars, |
| | 4 pieces of ½ worn pillowcases, 4 pieces of ½ |
| | worn T-shirts are included. |
| Soil | 8xSBL2004 sheets |
| repetition | 1 cycle wash |

### Panel Evaluation on Real Items

Panel test is built on visual cleanness appearance/dinginess assessment by 8 panelists. To increase the panel differentiation, real items are cut into 2 equal pieces and washed by 2 conditions which is compared in pair.

Panelists are asked to give their preference according to cleaning appearance (or dinginess) of each real item after wash in pair. Preference % is the percentage of the panelists who prefer a certain test condition (in this trial the number of panelists who prefer one condition over the other condition, e.g. a reference, divided by total of 8 panelists, calculated into %).

### Light Reflectance Measurement

After washing and rinsing the swatches were spread out flat and allowed to air dry at room temperature overnight. All washes are evaluated the day after the wash. Brightness or whiteness can also be expressed as the Remission (REM or R), which is a measure for the light reflected or emitted from the test material when illuminated with white light. The Remission of the textiles is measured at 460 nm using a Macbeth Color Eye 7000 reflectance spectrophotometer with very small aperture. The measurements were made without UV in the incident light and remission at 460 nm was extracted. The measurements are done per the manufacturer's protocol. The wash performance can be indicated by the sum of remission values on all tested swatches, or sum of the Delta REM on all tested swatches. The Delta REM is relative to a corresponding reference.

### Example 1: Stain Removal Performance

The stain removal performance of partially replacing ethoxylated poly(ethyleneimine) polymer with cellulase is carried out under EU FSW conditions on 14 AISE stains. The test materials and wash conditions are as described in Test #1. As the ethoxylated poly(ethyleneimine) polymer, Sokalan HP20 (abbreviated as HP20) purchased from BASF company is used. Results are shown in below table E1.

From table E1 it is clear that there is no performance loss (Sum R 705 vs 706) when HP20 is reduced from a regular level (4 wt %) to 1 wt %, but a minor performance loss (Sum R 705 vs 699) is observed when HP20 is completely removed from the detergent. Under both the regular and the reduced level of HP20, addition of cellulase can slightly improve the wash performance.

TABLE E1
Sum of remission on 14 AISE stains

| HP 20 | Formulated cellulase | Formulated cellulase | Sum of |
|---|---|---|---|
| (wt % in | SEQ ID NO: 11 | SEQ ID NO: 12 | Remission |
| detergent) | (wt % in detergent) | (wt % in detergent) | (Sum R) |
| 4 (reference) | 0 | 0 | 705 |
| 4 | 0.2 | 0 | 712 |
| 1 | 0 | 0 | 706 |
| 1 | 0.2 | 0 | 708 |
| 1 | 0 | 0.2 | 707 |
| 0 | 0 | 0 | 699 |
| 0 | 0 | 0.2 | 707 |
| 0 | 0.2 | 0 | 700 |

### Example 2: Whiteness Performance Evaluation on White Tracers

Example 2a: The Whiteness performance is evaluated under both the EU and the US wash conditions by FSW method on a broad range of white tracers with typical EU or US HDL type of detergent. Experimental details are as described in Test #2. Wash results are summarized in below tables E2-E3.

TABLE E2
Sum of delta remission (Delta REM) on white
tracers washed under EU FSW conditions

| | Formulated | Formulated | Sum of | Sum of | Sum of |
|---|---|---|---|---|---|
| | cellulase | cellulase | Delta | Delta | Delta |
| HP 20 | SEQ ID NO: 11 | SEQ ID NO: 12 | REM On | REM On | REM On |
| (wt % in | (ppm in | (ppm in | natural | mixed | synthetic |
| detergent) | wash liquor) | wash liquor) | textile | textile | textile |
| 5 (reference) | 0 | 0 | 0 | 0 | 0 |
| 1 | 0 | 0 | 5 | 2 | −3 |
| 1 | 0.08 | 0 | 16 | 5 | −5 |
| 1 | 0 | 0.08 | 40 | 14 | −6 |
| 1 | 0 | 0.24 | 45 | 15 | −5 |

TABLE E3
Sum of delta remission (Delta REM) on white
tracers washed under US FSW conditions

| | Formulated | Formulated | Sum of | Sum of | Sum of |
|---|---|---|---|---|---|
| | cellulase | cellulase | Delta | Delta | Delta |
| HP 20 | SEQ ID NO: 11 | SEQ ID NO: 12 | REM On | REM On | REM On |
| (wt % in | (wt % in | (wt % in | natural | mixed | synthetic |
| detergent) | detergent) | detergent) | textile | textile | textile |
| 5 (reference) | 0 | 0 | 0 | 0 | 0 |
| 1 | 0 | 0 | 9 | −1 | −2 |
| 1 | 0.12 | 0 | 24 | 4 | −4 |
| 1 | 0 | 0.11 | 50 | 18 | 0 |
| 1 | 0 | 0.21 | 59 | 25 | −6 |

According to tables E2 and E3, the detergent with low HP20 level (1 wt %) shows a decreased whiteness performance mainly on synthetic textiles. Addition of cellulase to the detergent with low level HP20 provides improved whiteness performance, suggesting that partly replacing the HP20 polymer with cellulase can provide additional whiteness benefit.

Example 2b: The Whiteness performance is further evaluated by TOM method on a broad range of white tracers with a typical EU Pod (or unit dose) type of detergent. Experimental details are as described in Test #3. Wash results are summarized in below tables E4.

TABLE E4
Sum of delta remission (Delta REM) on white
tracers washed under EU TOM conditions

| | Formulated | Formulated | Sum of | Sum of | Sum of |
|---|---|---|---|---|---|
| | cellulase | cellulase | Delta | Delta | Delta |
| HP 20 | SEQ ID NO: 11 | SEQ ID NO: 12 | REM On | REM On | REM On |
| (wt % in | (wt % in | (wt % in | natural | mixed | synthetic |
| detergent) | detergent) | detergent) | textiles | textiles | textiles |
| 5 (reference) | 0 | 0 | 0 | 0 | 0 |
| 1 | 0 | 0 | −4 | −8 | −3 |
| 1 | 0.08 | 0 | 5 | −2 | −4 |
| 1 | 0.24 | 0 | 12 | 5 | −1 |
| 1 | 0 | 0.1 | 64 | 37 | −2 |
| 1 | 0 | 0.3 | 72 | 42 | 0 |

From table E4, it can be seen that for EU Pod detergent, reducing the amount of HP20 polymer from the regular level of 5 wt % to 1 wt % results in a whiteness performance loss on tested white tracers. The addition of cellulase can compensate the whiteness loss or even greatly improve the whiteness performance on natural textiles and mixed textiles.

### Example 3: Wash Performance Evaluation on Real Items

The overall wash performance is also evaluated on real items by FSW method. Experimental details are as described in Test #3.

TABLE E5
tested conditions

| | | Formulated | Formulated | Formulated |
|---|---|---|---|---|
| | | cellulase | cellulase | DNase |
| | HP 20 | SEQ ID NO: 11 | SEQ ID NO: 12 | SEQ ID NO: 14 |
| Condition | (wt % in | (wt % in | (wt % in | (wt % in |
| code | detergent) | detergent) | detergent) | detergent) |
| 1 (reference) | 4 | 0.2 | 0 | 0 |
| 2 | 1 | 0.2 | 0 | 0 |
| 3 | 1 | 0 | 0.2 | 0 |
| 4 | 1 | 0 | 0.2 | 0.8 |

In the above table, condition 1 represents a typical commercial detergent containing regular amount of polymer (HP20) and cellulase, therefore condition 1 is used here as a reference detergent. Condition 2 is with reduced amount of polymer compared to the reference and is included to investigate whether there is a performance loss on real items when HP20 polymer level is reduced.

TABLE E6
Preference % of test conditions

| | Averaged | Averaged | Averaged | Averaged |
|---|---|---|---|---|
| | preference % | preference % | preference % | preference % |
| | on Collars | on pillowcases | on T-shirts | on all items |
| Prefer condition 2 | 44% | 10% | 53% | 36% |
| over condition 1 | | | | |
| Prefer condition 3 | 55% | 43% | 53% | 50% |
| over condition 1 | | | | |
| Prefer condition 4 | 69% | 58% | 70% | 66% |
| over condition 1 | | | | |
| Prefer condition 4 | 58% | 75% | 63% | 65% |
| over condition 3 | | | | |

From the panel test results shown in Table E6, it is clear that there is a performance loss on real items (collars, pillowcase and T-shirts) when reducing the amount of HP20 polymer, as condition 2 is less preferred (36%) over condition 1. Cellulase SEQ ID NO:12 dosed at 0.2 wt % can compensate the loss (condition 3 is preferred same as condition 1). By combing DNase SEQ ID NO:14 with cellulase can further improve the overall cleanness of real items (condition 4 are more preferred over condition 1 or 3).

1. A detergent composition comprising from 0.5% to 2% by weight of an ethoxylated poly(ethyleneimine) polymer, from 0.0001% to 5% (w/w) active enzyme protein of a polypeptide having cellulase activity, and optionally at least one additional enzyme, and a detergent adjunct ingredient.

2. The detergent composition according to claim 1 comprising from 0.5 to 1.5%, such as 0.7 to 1.3%, such as 0.8 to 1.2% such as 0.9 to 1.1% by weight, preferably about 1% by weight, of an ethoxylated poly(ethyleneimine) polymer, from 0.0001% to 5% (w/w) active enzyme protein of a polypeptide having cellulase activity, and optionally at least one additional enzyme, and a detergent adjunct ingredient.

3. The detergent composition according to claim 1 comprising from 0.001% to 1% (w/w) active enzyme protein of a polypeptide having cellulase activity.

4. The detergent composition according to claim 1, wherein the polypeptide having cellulase activity is obtained from a fungal source, preferably Humicola insolens or Thielavia terrestris or a bacterial source, preferably alkaline Bacillus akibai or Paenibacillus polymyxa.

5. The detergent composition according to claim 1 wherein the polypeptide having cellulase activity is selected from the group of cellulases belonging to glycoside hydrolase family 5 (GH5), glycoside hydrolase family 7 (GH7), glycoside hydrolase family 12 (GH12), glycoside hydrolase family 44 (GH44), glycoside hydrolase family 45 (GH45), EC 3.2.1.4, EC 3.2.1.21, EC 3.2.1.91 or EC 3.2.1.172.

6. The detergent composition according to claim 1, further comprising a deoxyribonuclease obtained from a fungal source, preferably Aspergillus, e.g., A. oryzae or from a bacterial source, preferably Bacillus, e.g. B. cibi.

7. The detergent composition according to claim 1, wherein the polypeptide having cellulase activity has an amino acid sequence selected from the group consisting of SEQ ID NO: 10, SEQ ID NO: 11, SEQ ID NO: 12 and SEQ ID NO: 13, or a cellulase that has an amino acid sequence having at least 60%, at least 65%, at least 70%, at least 75%, at least 80%, at least 85%, at least 90%, at least 95%, at least 96%, at least 97%, at least 98%, or at least 99% sequence identity to any of SEQ ID NO: 10, SEQ ID NO: 11, SEQ ID NO: 12 and SEQ ID NO: 13.

8. The detergent composition according to claim 1, wherein the optionally at least one additional enzyme has an amino acid sequence selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14 or a polypeptide having at least 60%, at least 65%, at least 70%, at least 75%, at least 80%, at least 85%, at least 90%, at least 95%, at least 96%, at least 97%, at least 98%, or at least 99% sequence identity thereto.

9.-20. (canceled)

21. A method for the improvement of the sustainability profile of a detergent composition the method comprising replacing partly or fully ethoxylated poly(ethyleneimine) polymers of the detergent composition with a polypeptide having cellulase activity, optionally in combination with at least one additional enzyme, wherein the sustainability profile of the detergent composition is improved when one or more ethoxylated poly(ethyleneimine) polymers of the detergent composition is replaced partly or fully with the polypeptide having cellulase activity.

22. The method according to claim 21, wherein the polypeptide having cellulase activity is selected from the group consisting of cellulases belonging to glycoside hydrolase family 5 (GH5), glycoside hydrolase family 7 (GH7), glycoside hydrolase family 12 (GH12), glycoside hydrolase family 44 (GH44) and glycoside hydrolase family 45 (GH45), EC 3.2.1.4, EC 3.2.1.21, EC 3.2.1.91 and EC 3.2.1.172.

23. The method according to claim 21, wherein the polypeptide having cellulase activity is obtained from a fungal source, preferably Humicola insolens or Thielavia terrestris or a bacterial source, preferably Bacillus akibai or Paenibacillus polymyxa.

24. The method according to claim 21, wherein the polypeptide having cellulase activity has an amino acid sequence selected from the group consisting of SEQ ID NO: 10, SEQ ID NO: 11, SEQ ID NO: 12 and SEQ ID NO: 13, or a cellulase that has an amino acid sequence having at least 60%, at least 65%, at least 70%, at least 75%, at least 80%, at least 85%, at least 90%, at least 95%, at least 96%, at least 97%, at least 98%, or even at least 99% sequence identity to any of SEQ ID NO: 10, SEQ ID NO: 11, SEQ ID NO: 12 and SEQ ID NO: 13.

25. The method of claim 21, wherein the polypeptide having cellulase activity is in combination with at least one additional enzyme, wherein the at least one additional enzyme is selected from the group consisting of protease, amylase, deoxyribonuclease, lipase, xyloglucanase, cutinase, pectinase, pectin lyase, xanthanases, peroxidase, haloperoxygenases, catalase and mannanase.

26. The method of claim 25, wherein the additional enzyme is a deoxyribonuclease.

27. The method of claim 26, wherein the deoxyribonuclease is obtained from a fungal source, preferably Aspergillus, e.g., A. oryzae or from a bacterial source, preferably Bacillus, e.g. B. cibi.

28. The method of claim 26, wherein the deoxyribonuclease has an amino acid sequence selected from the group consisting of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14, or a deoxyribonuclease that has an amino acid sequence having at least 60%, at least 65%, at least 70%, at least 75%, at least 80%, at least 85%, at least 90%, at least 95%, or at least 99% sequence identity to any of SEQ ID NO: 1, SEQ ID NO: 2, SEQ ID NO: 3, SEQ ID NO: 4, SEQ ID NO: 5, SEQ ID NO: 6, SEQ ID NO: 7, SEQ ID NO: 8, SEQ ID NO: 9 and SEQ ID NO: 14.

29. The method of claim 25, wherein the at least one additional enzyme is present in the detergent composition in an amount corresponding to from 0.001% to 5%, more preferably from 0.005% to 5%, more preferably from 0.005% to 4%, more preferably from 0.005% to 3%, more preferably from 0.005% to 2%, even more preferably from 0.01% to 2%, and most preferably from 0.01% to 1% (w/w) active enzyme protein.

30. The method of claim 21, wherein the polypeptide having cellulase activity is present in the detergent composition in an amount corresponding to from 0.0001% to 5% (w/w) active enzyme protein.

31. The method of claim 21, wherein the polypeptide having cellulase activity is present in the detergent composition in an amount corresponding to from 0.001% to 1% (w/w) active enzyme protein.

32. The method of claim 21, wherein the detergent is for laundering of a textile, preferably a cellulose based textile or a blend of cellulose based and non-cellulose based textiles.

33. The method of claim 21, wherein the polypeptide having cellulase activity is biodegradable.
